(19) United States
(12) Patent Application Publication
(10) Pub. No.: US 2010/0238852 A1
(43) Pub. Date: Sep. 23, 2010

(54) DIGITAL BROADCASTING SYSTEM AND BROADCASTING RECEIVER

(76) Inventors: Yuka Fujita, Tokyo (JP); Kouichi Hiramatsu, Tokyo (JP)

Correspondence Address: BIRCH STEWART KOLASCH & BIRCH, PO BOX 747, FALLS CHURCH, VA, 22040-0747, US

(21) Appl. No.: 12/738,197

(22) PCT Filed: Nov. 19, 2008
(86) PCT No.: PCT/JP2008/003391

§ 371 Date: Apr. 15, 2010

(30) Foreign Application Priority Data
Jan. 7, 2008 (JP) 2008-000506

(51) Int. Cl. H04H 20/71

(52) U.S. Cl. 370/312

(57) ABSTRACT

In a digital broadcasting system including a plurality of service providing means each for providing a broadcasting service sent from a broadcasting network, a broadcasting facility P which is provided for each of the service providing means, and a broadcasting receiver 10 for receiving a broadcasting service which the broadcasting facility P provides via one IP network 7, the broadcasting facility P provides a broadcasting network identifier for identifying the type of the broadcasting network, a broadcasting facility identifier for identifying the broadcasting facility P, a service providing means identifier for identifying the service providing means, and a service identifier for identifying the broadcasting service, and the broadcasting receiver 10 specifies the broadcasting network identifier, the broadcasting facility identifier, the service providing means identifier, and the service identifier to specify a broadcasting service.

### FIELD OF THE INVENTION

The present invention relates to a broadcasting system and a broadcast receiving technology associated with digital broadcasting.

### BACKGROUND OF THE INVENTION

A conventional digital broadcasting system is configured in such a way as to display pieces of network information about a plurality of networks currently being connected thereto on an identical screen by using functions specific to broadcasting receivers in order to enable users to easily select a network, and to switch among the networks according to a user's selection (refer to patent reference 1). Furthermore, in order to enable a plurality of broadcasting receivers which can be connected to different networks respectively to continuously receive an identical service, a notification of network_id/transport_id is made among the receivers, so that a channel selection of the identical service is implemented among the different terminals and the different networks (refer to patent reference 2).
[Patent reference 1] JP,2006-217430,A pp. 2 to 8 and FIG. 1
[Patent reference 2] JP,2006-067198,A pp. 2 to 11 and FIG. 1

A problem with the conventional digital broadcasting system which is configured as mentioned above is that unless a function, such as a remote control, specific to a receiver is used, any channel selection cannot be carried out beyond networks.

The present invention is made in order to solve the above-mentioned problem, and it is therefore an object of the present invention to implement selection of a service provided by a different network according to a broadcast content made on the basis of an intention of a broadcasting station. It is another object of the present invention to carry out a simultaneous playback of a broadcast content according to an intention of a broadcasting station with reference to broadcast data of a different network displayed in a screen in which another broadcast content is being played back.

### DISCLOSURE OF THE INVENTION

In accordance with the present invention, there is provided a digital broadcasting system including a plurality of service providing means each for providing a broadcasting service sent from a broadcasting network, a broadcasting facility which is provided for each of the above-mentioned service providing means, and a broadcasting receiver for receiving a broadcasting service which the above-mentioned broadcasting facility provides via one IP network, in which the above-mentioned broadcasting facility provides a broadcasting network identifier for identifying a type of the above-mentioned broadcasting network, a broadcasting facility identifier for identifying the above-mentioned broadcasting facility, a service providing means identifier for identifying the above-mentioned service providing means, and a service identifier for identifying the above-mentioned broadcasting service, and the above-mentioned broadcasting receiver specifies the above-mentioned broadcasting network identifier, the above-mentioned broadcasting facility identifier, the above-mentioned service providing means identifier, and the above-mentioned service identifier to specify a broadcasting service.

Because the digital broadcasting system in accordance with the present invention is configured in such a way as to add a broadcasting network identifier, a broadcasting facility identifier, a service providing means identifier, and a service identifier to a broadcast service to be provided, the digital broadcasting system can specify a desired broadcast service by specifying the broadcasting network identifier, the broadcasting facility identifier, the service providing means identifier, and the service identifier in the broadcasting receiver even when broadcast programs or service identifiers provided by different broadcast services are the same.

### BRIEF DESCRIPTION OF THE FIGURES

FIG. 1 is a view showing the configuration of a digital broadcasting system in accordance with Embodiment 1 of the present invention;

FIG. 2 is a view showing the configuration of an IP broadcasting station group of the digital broadcasting system in accordance with Embodiment 1 of the present invention;

FIG. 3 is a view showing an example of configuration management information for use in the digital broadcasting system in accordance with Embodiment 1 of the present invention;

FIG. 4 is a view showing an example of an SI stream for use in the digital broadcasting system in accordance with Embodiment 1 of the present invention;

FIG. 5 is a block diagram showing the configuration of a digital broadcasting receiver in accordance with Embodiment 1 of the present invention;

FIG. 6 is a view showing an example of a procedure description for use in the digital broadcasting system in accordance with Embodiment 1 of the present invention;

FIG. 7 is a view showing an example of a BML document including the procedure description shown in FIG. 6;

FIG. 8 is a block diagram showing the configuration of a digital broadcasting receiver in accordance with Embodiment 2 of the present invention;

FIG. 9 is a view showing an example of a procedure description for use in the digital broadcasting system in accordance with Embodiment 2 of the present invention;

FIG. 10 is a view showing an example of the procedure description for use in the digital broadcasting system in accordance with Embodiment 2 of the present invention;

FIG. 11 is a view showing an example of a BML document including the procedure descriptions shown in FIGS. 6, 9, and 10;

FIG. 12 is a block diagram showing the configuration of a digital broadcasting receiver in accordance with Embodiment 3 of the present invention;

FIG. 13 is a view showing an example of a procedure description for use in the digital broadcasting system in accordance with Embodiment 3 of the present invention;

FIG. 14 is a view showing an example of the procedure description for use in the digital broadcasting system in accordance with Embodiment 3 of the present invention;

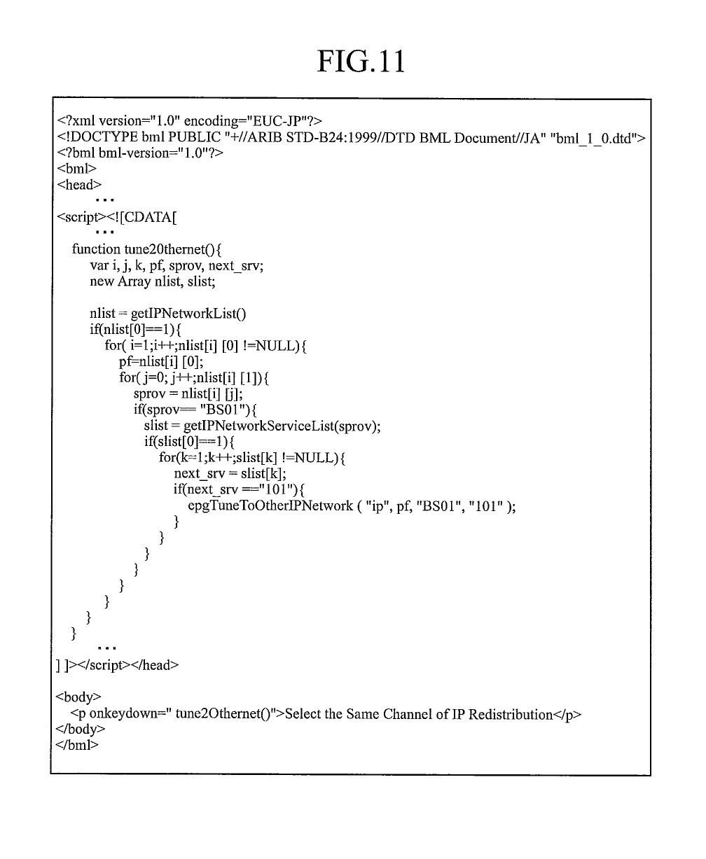

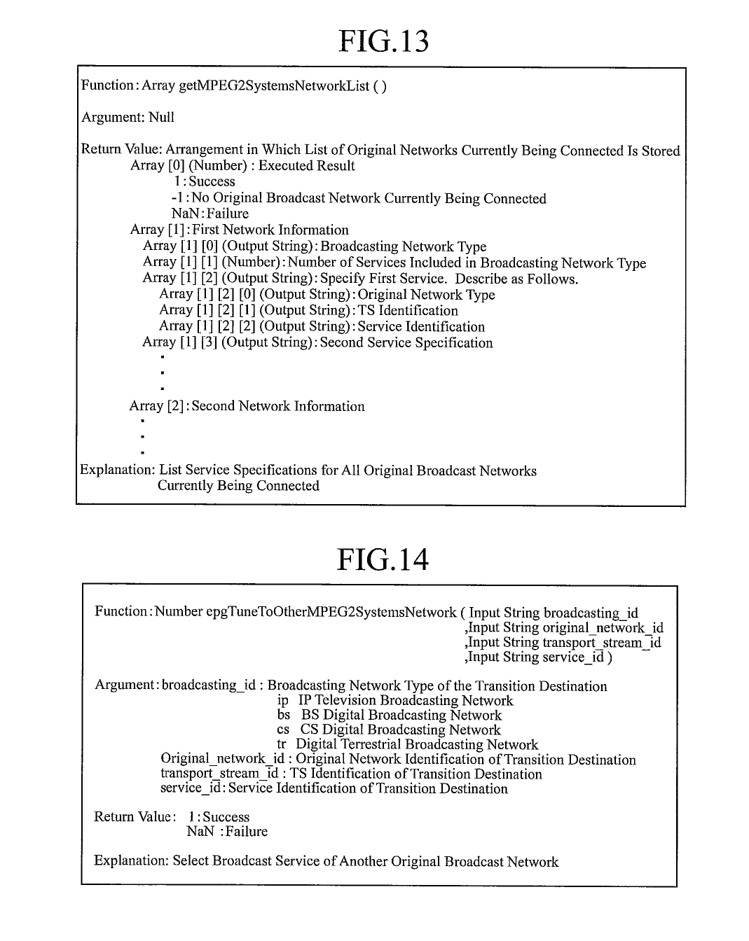

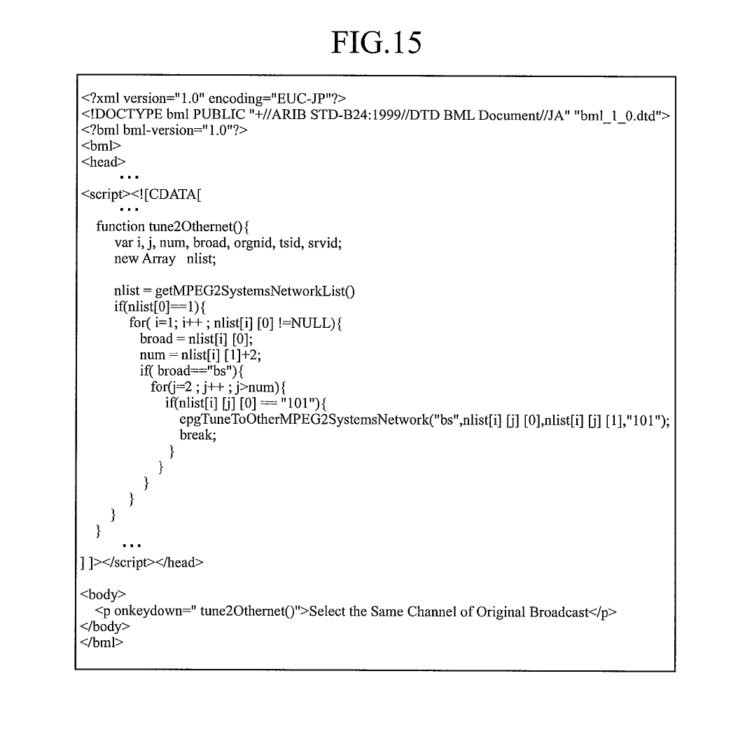

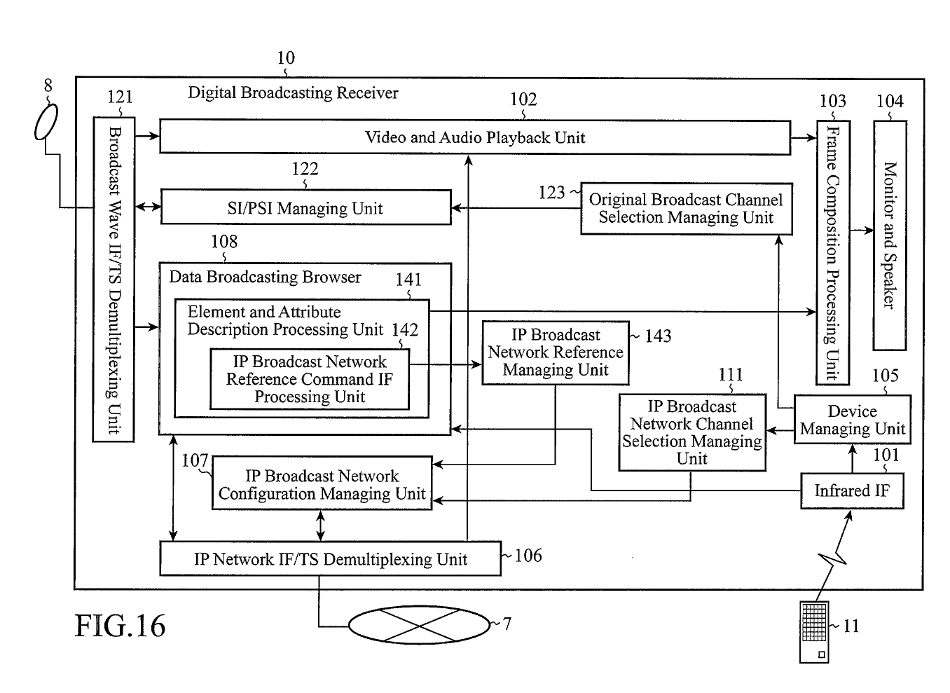

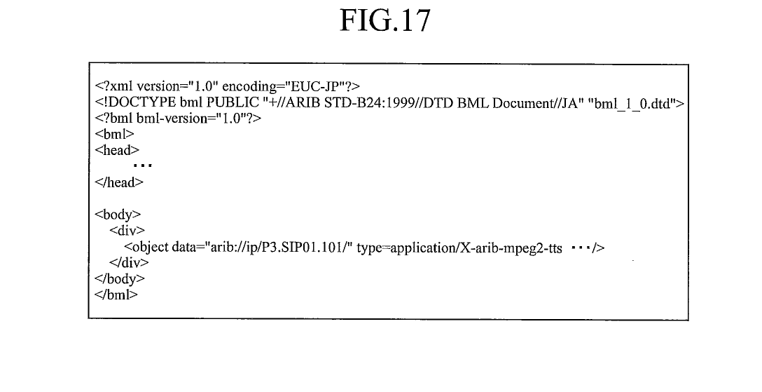

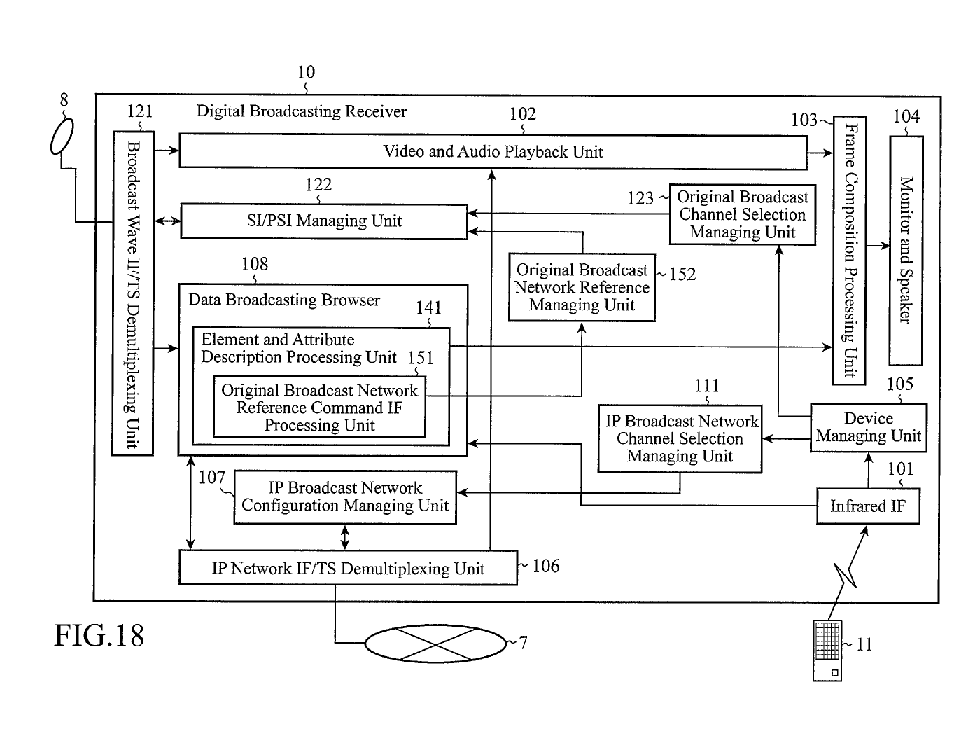

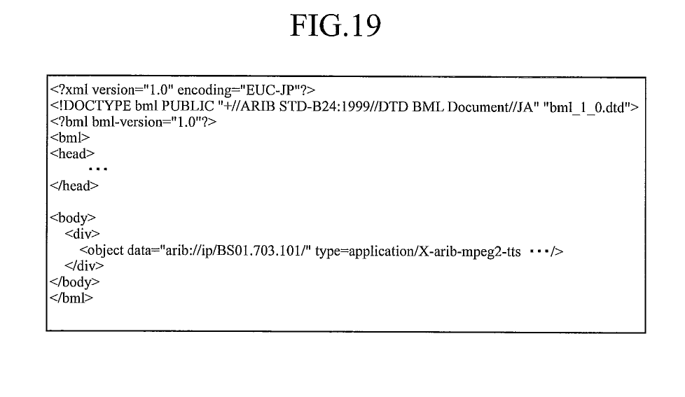

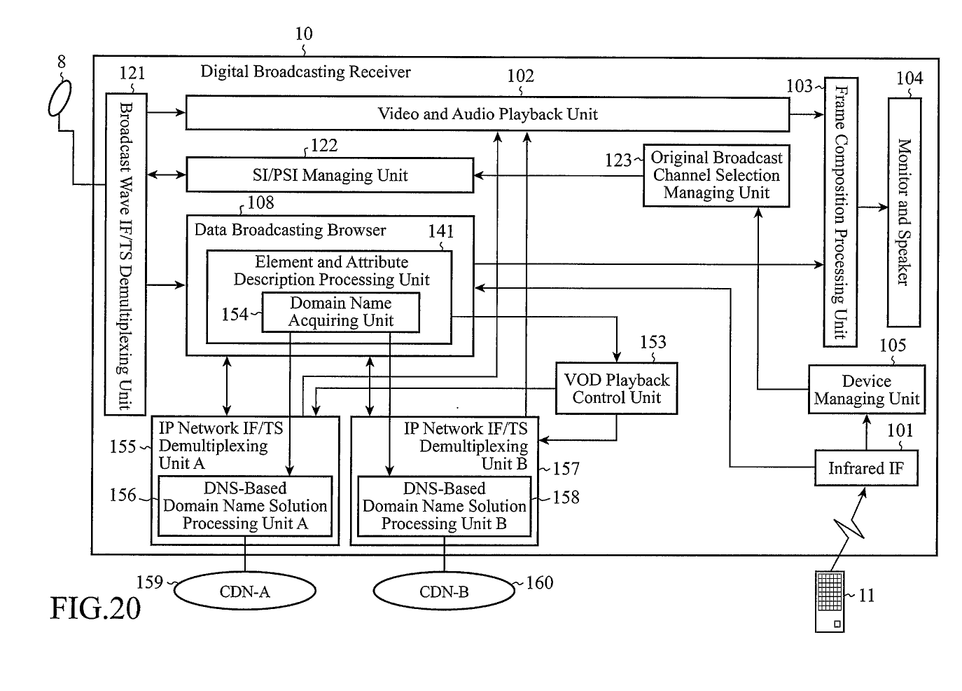

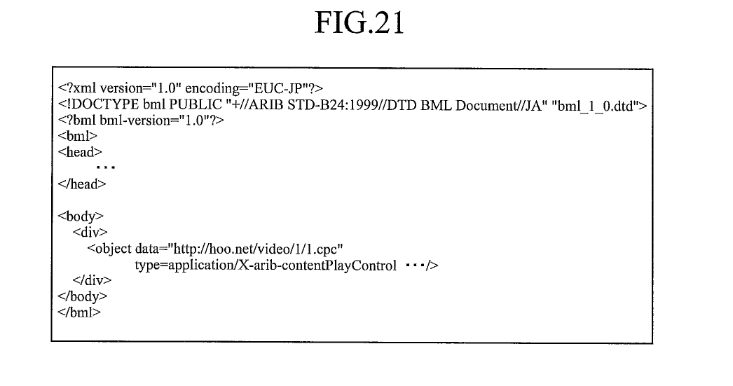

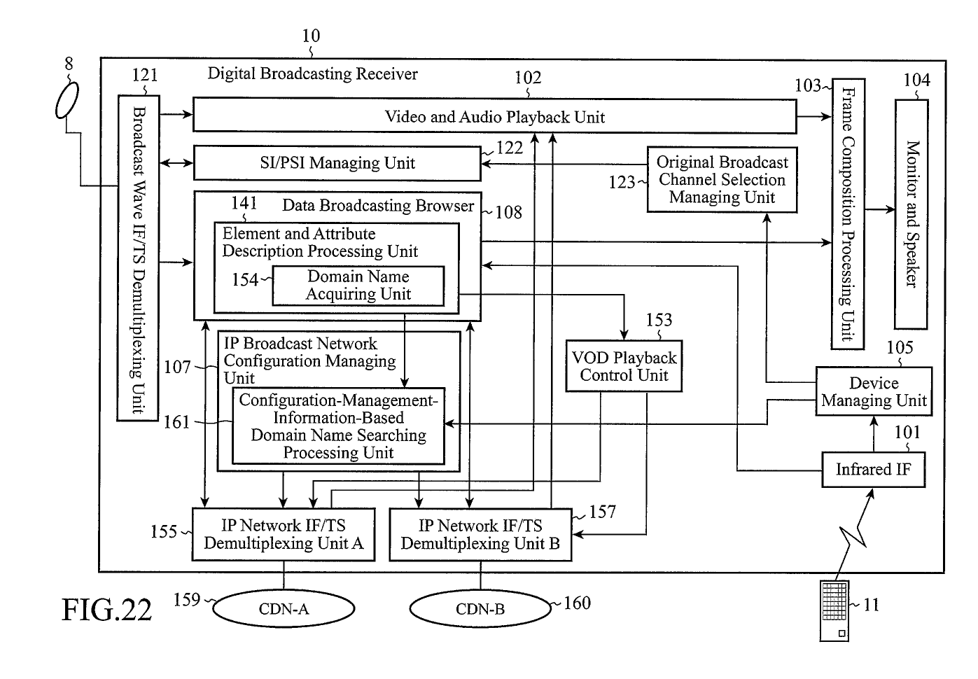

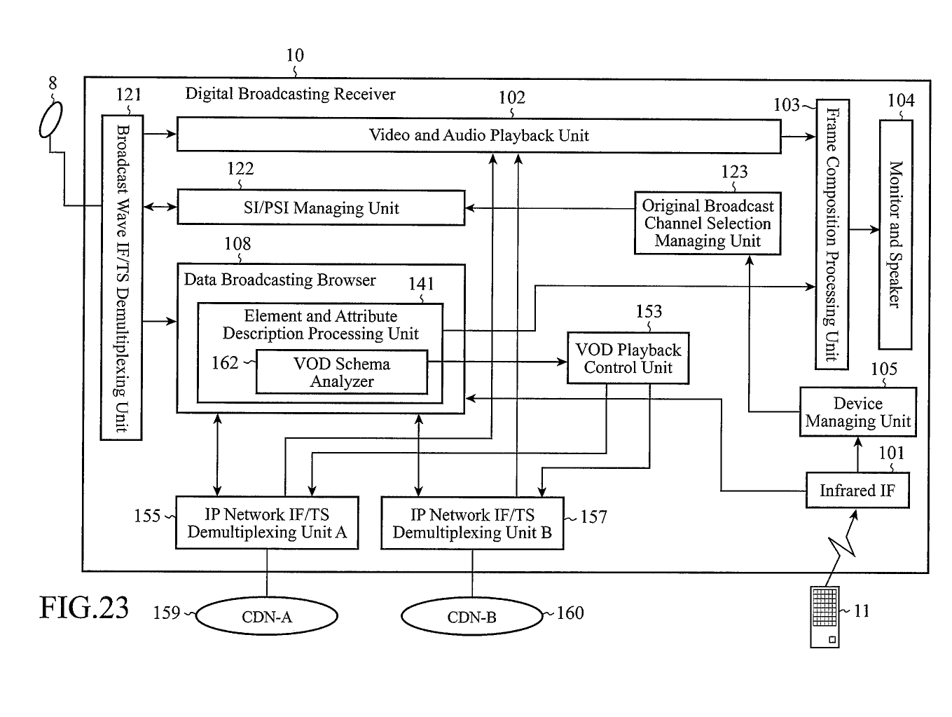

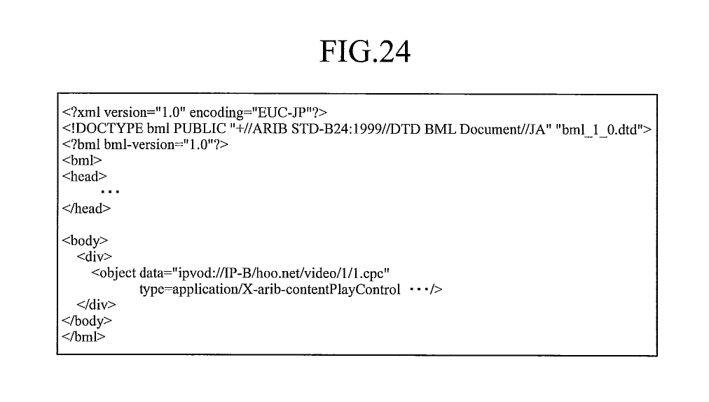

FIG. 11 is a view showing an example of a BML document including the procedure descriptions shown in FIGS. 13 and 14;

FIG. 16 is a block diagram showing the configuration of a digital broadcasting receiver in accordance with Embodiment 4 of the present invention;

FIG. 17 is a view showing an example of a BML document for use in the digital broadcasting receiver in accordance with Embodiment 4 of the present invention;

FIG. 18 is a block diagram showing the configuration of a digital broadcasting receiver in accordance with Embodiment 5 of the present invention;

FIG. 19 is a view showing an example of a BML document for use in the digital broadcasting receiver in accordance with Embodiment 5 of the present invention;

FIG. 20 is a block diagram showing the configuration of a digital broadcasting receiver in accordance with Embodiment 6 of the present invention, and a view showing the configuration of a digital broadcasting system in accordance with Embodiment 6 of the present invention;

FIG. 21 is a view showing an example of a BML document for use in the digital broadcasting receivers in accordance with Embodiments 6 and 7 of the present invention;

FIG. 22 is a block diagram showing the configuration of a digital broadcasting receiver in accordance with Embodiment 7 of the present invention, and a view showing the configuration of a digital broadcasting system in accordance with Embodiment 7 of the present invention;

FIG. 23 is a block diagram showing the configuration of a digital broadcasting receiver in accordance with Embodiment 8 of the present invention, and a view showing the configuration of a digital broadcasting system in accordance with Embodiment 8 of the present invention; and

FIG. 24 is a view showing an example of a BML document for use in the digital broadcasting receiver in accordance with Embodiment 8 of the present invention.

### PREFERRED EMBODIMENTS OF THE INVENTION

Hereafter, in order to explain this invention in greater detail, the preferred embodiments of the present invention will be described with reference to the accompanying drawings.

### Embodiment 1

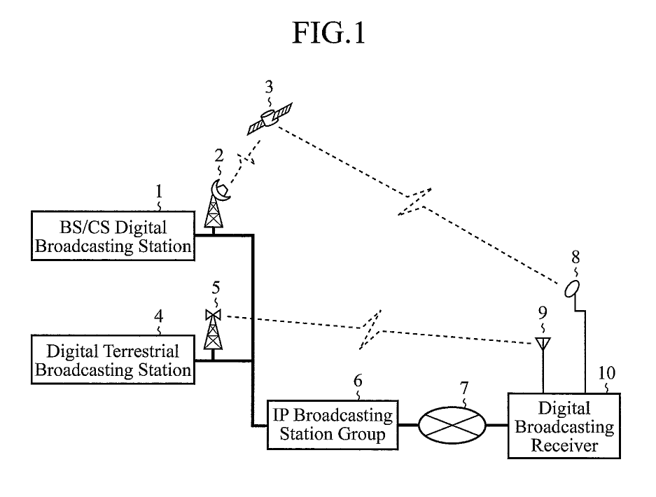

FIG. 1 is a view showing the configuration of a digital broadcasting system in accordance with Embodiment 1 of the present invention.

The digital broadcasting system is comprised of a BS/CS digital broadcasting station 1, a BS/CS digital broadcasting antenna 2, a satellite 3 for relaying a radio wave from the BS/CS digital broadcasting antenna 2, a digital terrestrial broadcasting station 4, a digital terrestrial transmitting antenna 5, an IP broadcasting station group 6, an IP network 7, a BS/CS digital receiving antenna 8 installed in a user's house, a digital terrestrial receiving antenna 9 installed in the user's house, and a digital broadcasting receiver (a broadcasting receiver) 10.

First, a broadcasting service (a method currently used in Japan) using a broadcast wave in conformity with the MPEG-2 SYSTEMS which serve as foundations for constructing the digital broadcasting system in accordance with the invention in this application will be explained.

The BS/CS digital broadcasting station 1 forms broadcast data in conformity with the MPEG-2 SYSTEMS, and sends a broadcast wave to each home via the satellite 3 from the BS/CS digital transmission antenna 2. The digital terrestrial broadcasting station 4 similarly forms broadcast data in conformity with the MPEG-2 SYSTEMS, and sends a broadcast wave to each home from the digital terrestrial transmitting antenna 5.

Next, terms about a multiplexing method for use in various types of digital television broadcasting in conformity with the MPEG-2 SYSTEMS will be explained. An explanation about the standards for various types of digital television broadcasting in conformity with the MPEG-2 SYSTEMS will be omitted hereafter. In digital broadcasting in conformity with the MPEG-2 SYSTEMS, a broadcast program is called an event, and a series of events continuously organized, which is typically called a “channel”, is called a service. In addition, a plurality of services are multiplexed and a TS (Transport Stream) is formed, so that program multiplexing is implemented. In order to identify such organization independently and to present the attributes of data multiplexed to a TS, PSI (Program Specific Information) and SI (Service Information) are multiplexed into the TS according to the MPEG-2 SYSTEMS.

Among the SI, an SDT (Service Description Table) includes pieces of information about a channel selection operation by each receiver, such as a service name, a service identification, and a TS identification for transmitting the service identification, and an NIT (Network Information Table) includes pieces of information about a transmission network, such as a service identification, a modulation method, a network identification showing a network via which the TS is being transmitted, an original network identification showing network information which has been transmitted for the first time. These network identifications are given to each of networks and to each of broadcasting organizations (e.g., NHK, SKY PerfecTV!, and so on) individually. Similarly, the service identification is given to each service individually and the event identification is given to each event individually, and all the broadcast programs can be discriminated from one another by specifying the three types of information including the original network identification, the TS identification, and the service identification for each of the broadcast programs.

Furthermore, by using the TS identification, a PAT (Program Association Table) and a PMT (Program Specific Information) can be looked up, and a PID (Packet ID) with which a mono medium, such as video, audio, or data, which is included in a TS in question shown in the PMT is specified. Furthermore, in the SI, as all stations' SIs, information showing that the configuration of all the broadcasting services to be broadcast via an identical broadcast network is to be provided as a brief description is incorporated (refer to the ARIB TR-B15 standards).

In BS/CS digital broadcasting, all the pieces of service information described in each NIT can be used as acquisition of information about all stations in a network in conformity with the MPEG-2 SYSTEMS, while in digital terrestrial broadcasting, because each NIT is configured in such a way as to include only self-service information, if it is determined by checking all the frequencies that a TS can be received, information is acquired from the NIT included in the TS.

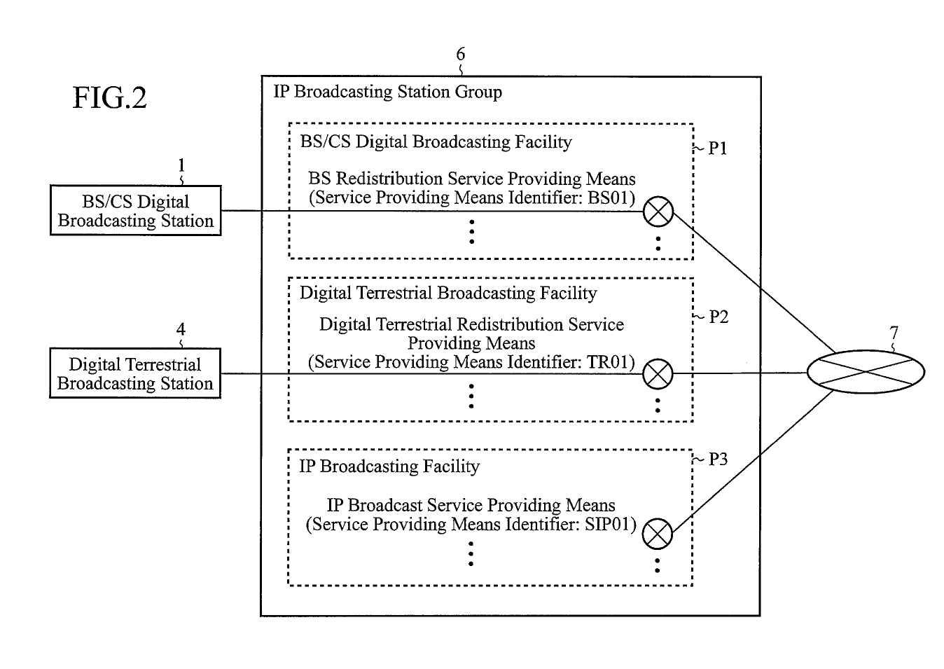

Next, the configuration of the IP broadcasting station group 6 will be explained. FIG. 2 is a view showing the configuration of the IP broadcasting station group of the digital broadcasting system in accordance with Embodiment 1 of the present invention. The IP broadcasting station group 6 is comprised of a plurality of service providing means each for providing a broadcasting service via the Internet, and a plurality of broadcasting facilities P which are provided to the plurality of service providing means respectively. The plurality of broadcasting facilities P can provide a plurality of services via the single IP network 7.

In the example of FIG. 2, a BS/CS digital broadcasting facility P1 which redistributes an original broadcasting service from the BS/CS digital broadcasting station 1 through multicasting, a digital terrestrial broadcasting facility P2 which redistributes a broadcast program from the digital terrestrial broadcasting station 4 through multicasting, and an IP broadcasting facility P3 which distributes a program produced by a local station, as broadcasting, through multicasting constructs the single IP broadcasting station group 6, and, by using these broadcasting facilities P, a BS redistribution service providing means (a service providing means identifier: BS01), a digital terrestrial redistribution service providing means (a service providing means identifier: TR01), and an IP broadcasting service providing means (a service providing means identifier: SIP01) carry out broadcasting services respectively. Hereafter, an original broadcast and an original broadcasting service from the BS/CS digital broadcasting station 1 will be referred to as a “BS/CS original broadcast” and a “BS/CS original broadcasting service”, and a broadcast and a broadcasting service which are redistributed via the IP network 7 will be referred to as a “BS/CS redistribution broadcast” and a “BS/CS redistribution broadcasting service”.

In accordance with the present invention, in order to identify each broadcasting service individually, a service identifier for identifying the type of each broadcasting service, a service providing means identifier for identifying a corresponding service providing means, a broadcasting facility identifier for identifying a corresponding broadcasting facility, and a broadcasting network identifier for identifying the type of a corresponding broadcasting network, such as BS, CS, digital terrestrial, or IPTV, are added to each broadcasting service in each broadcasting facility P.

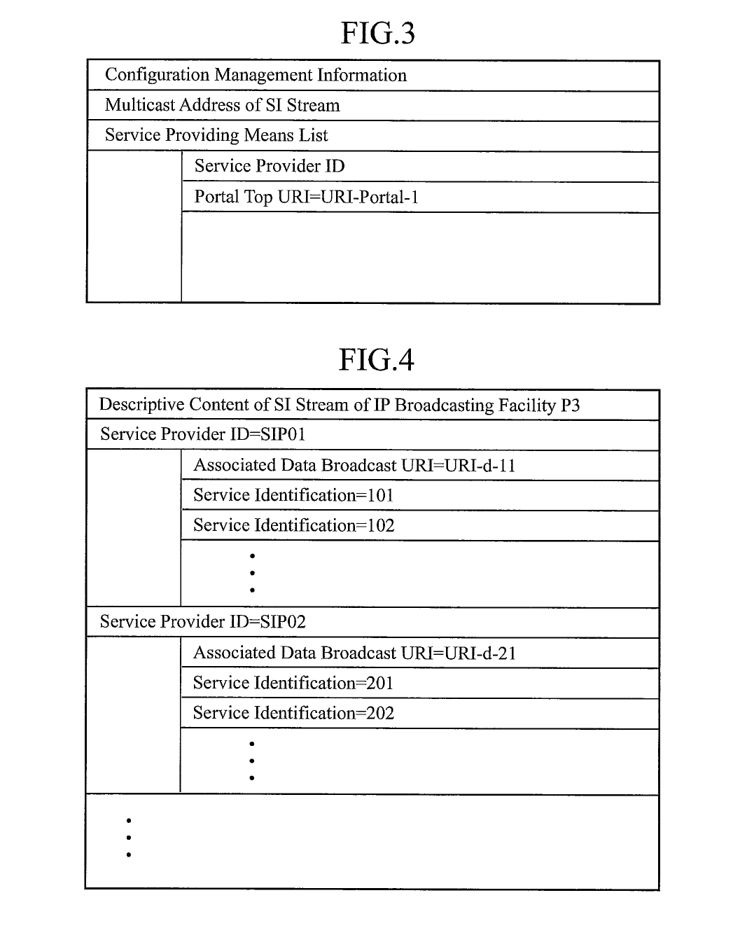

IP television broadcasting will be explained on the basis of the service configuration of the IP broadcasting facility P3 and with reference to FIGS. 3 and 4. FIG. 3 is a view showing an example of configuration management information for use in the digital broadcasting system in accordance with Embodiment 1 of the present invention, and FIG. 4 is a view showing an example of an SI stream in the digital broadcasting system in accordance with Embodiment 1 of the present invention. The IP broadcasting facility P3 has configuration management information which the IP broadcasting facility provides with a fixed URI (Uniform Resource Identifier) according to the HTTP, and this configuration management information is comprised of the multicast address of the SI stream and a list of IP broadcasting service providing means which are the members of the IP broadcasting facility.

The multicast address of the SI stream collectively provides the SIs regarding all the IP television broadcasting services provided by the IP broadcasting facility P3. Assuming that each service providing means is a network in conformity with the MPEG-2 SYSTEMS, an NID (Network Identification Number) included in the SI stream has both a multicast address used for distributing a TS including video and sound of each service identifier for each service providing means identifier through multicasting, and a URI to a related data broadcasting service. On the other hand, the service providing means list is comprised of service provider IDs, the URI of the top page of a portal website of each service provider ID, and so on. Furthermore, each service provider can provide a video on demand (VOD) content in addition to a service as mentioned above, and can support this service for providing a VOD content by describing a URI on a Web content such as the top page of the portal website.

The IP television broadcasting is explained above as an example. Also in a BS/CS digital redistribution service and a digital terrestrial redistribution service, configuration management information and an SI stream are provided, like in the case of IP television broadcasting. The BS/CS digital broadcasting facility P1 and the digital terrestrial broadcasting facility P2, demultiplexes TSs from the BS/CS digital broadcasting station 1 and the digital terrestrial broadcasting station 4 into SIs, PSIs, and mono media data respectively. In each SI among them, a multicast address used for distributing a TS including a mono medium is simply added to the NIT and no change is made to the service identifier, the network identifier, and so on, and each SI is delivered with the multicast address for the SI stream which is defined in the configuration management information. Coded data among the mono media data is subjected to the conversion of one encoding method to another (transcoding) as needed, and are remultiplexed with the PSI into a TS and this TS is distributed with the multicast address for mono medium which is added to the NIT.

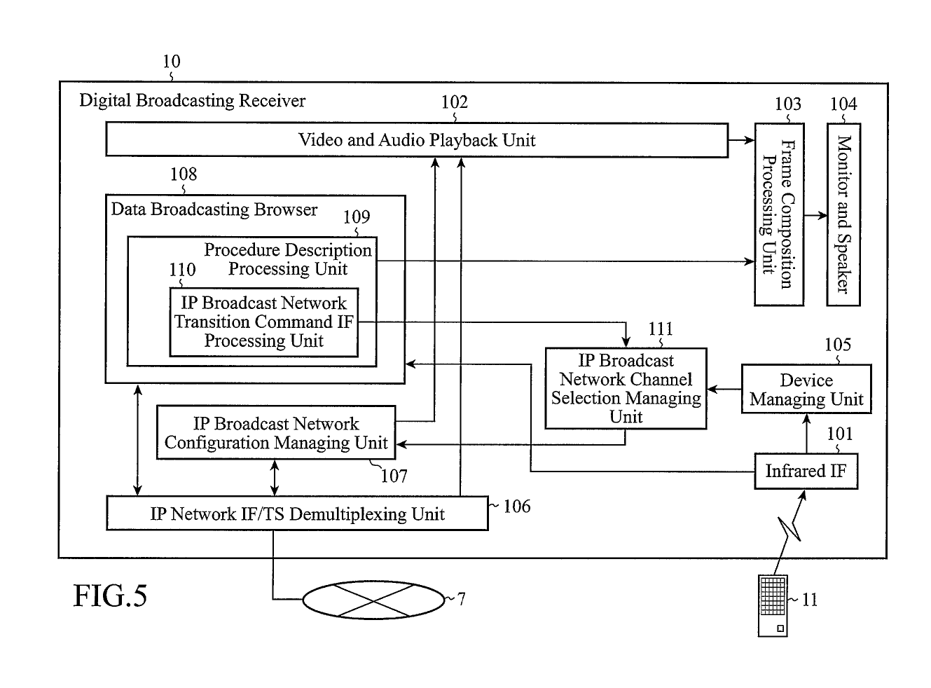

Next, the configuration of the digital broadcasting receiver 10 will be explained. FIG. 5 is a block diagram showing the configuration of the digital broadcasting receiver in accordance with Embodiment 1 of the present invention.

The digital broadcasting receiver 10 is comprised of a remote control 11 with which a viewer performs a channel change operation or the like, an infrared IF (interface) 101 for receiving an infrared ray sent out from the remote control 11, a video and audio playback unit 102 for decoding coded video and audio data inputted thereto to generate a video frame and an audio frame, a frame composition processing unit 103 for compositing a plurality of video frame data, image frame data, and audio frame data which are inputted thereto, a monitor and speaker 104 for outputting video and audio which are inputted thereto, a device managing unit 105 for setting up a input branch table and for issuing a command for selecting a service, an IP network IF/TS demultiplexing unit 106 for decoding transmission-line-encoded data of a received broadcast wave and for demultiplexing a TS to extract video and audio coded data for this broadcasting, a data broadcasting content, and so on from the TS, an IP broadcast network configuration managing unit 107 for expanding IP broadcast network channel selection management data, a data broadcasting browser (browser) 108 for playing back the data broadcasting content, a procedure description processing unit 109 built in the data broadcasting browser 108, for executing a procedure description which is included in the data broadcasting content, an IP broadcast network transition command IF processing unit (an IP broadcast network channel selection IF processing unit) 110 built in the procedure description processing unit 109, for commanding a channel selection of a broadcasting service specified by a broadcasting network identifier, a broadcasting facility identifier, a service providing means identifier, and a service identifier, and an IP broadcast network channel selection managing unit 111 for selecting a desired broadcasting service according to the specification of the broadcasting network identifier, the broadcasting facility identifier, the service providing means identifier, and the service identifier.

Next, the operation of this digital broadcasting receiver 10 will be explained. In the explanation of the operation, a case in which the digital broadcasting receiver make a transition from a broadcast content provided by a BS redistribution service to a broadcast content provided by an IP broadcasting service will be explained as an example. It is assumed that the BS redistribution service from which the digital broadcasting receiver makes a transition has a broadcasting network identification=ip, a broadcasting facility identification=P1, a service providing means identification=BS01, and a service identification=101, and the BS redistribution service will be described as ip/P1/BS01/101 hereafter. Similarly, it is assumed that the IP broadcasting service to which the digital broadcasting receiver makes a transition has a broadcasting network identification=ip, a broadcasting facility identification=P3, a service providing means identification=SIP01, and a service identification=101, and the IP broadcasting service will be described as ip/P3/SIP01/101 hereafter.

When electric power is first supplied to the digital broadcasting receiver 10 via the remote control 11, the infrared IF 101 notifies the device managing unit 105 that electric power has been supplied to the digital broadcasting receiver, and the device managing unit 105 sets an input branch table showing the notifying destination of a button input to the infrared IF 101 and also outputs an initialization command to the IP broadcast network configuration managing unit 107. The IP broadcast network configuration managing unit 107 acquires the configuration management information from the URIs of the pieces of configuration management information of all the predetermined broadcasting facilities in this system via the IP network IF/TS demultiplexing unit 106, expands the acquired pieces of configuration management information as IP broadcast network channel selection management data, and stores this IP broadcast network channel selection management data therein. The IP broadcast network configuration managing unit also acquires SI streams from the multicast addresses of the pieces of acquired configuration management information, and adds the SI streams to the IP broadcast network channel selection management data.

Next, when the BS redistribution service (the service identification=101) is selected via the remote control 11, the infrared IF 101 checks the input branch table and then outputs a channel selection command for selecting the BS distribution service (the service identification=101) to the device managing unit 105. The device managing unit 105 outputs the BS distribution service channel selection command to the IP broadcast network configuration managing unit 107 via the IP broadcast network channel selection managing unit 111. The device managing unit 105 checks to see whether or not the broadcasting service of “ip/P1/BS01/101” is being broadcast from the IP broadcast network channel selection management data stored therein, and, when the broadcasting service is being broadcast, notifies a start of reception of the broadcast to the IP broadcast network channel selection managing unit 111 and also acquires the multicast address and the TS identification with which the mono media data about the service are to be distributed, the multicast address and the TS identification being stored in the IP broadcast network channel selection management data, and outputs the multicast address and the TS identification to the IP network IF/TS demultiplexing unit 106.

The IP network IF/TS demultiplexing unit 106 demultiplexes the TS of the inputted multicast address to extract PSI information, and outputs this PSI information to the IP broadcast network configuration managing unit 107. The IP broadcast network configuration managing unit 107 acquires a plurality of PIDs of mono media data corresponding to the TS identification from this PSI, and notifies a start of reception of these mono media data to the IP network IF/TS demultiplexing unit 106. The IP network IF/TS demultiplexing unit 106 outputs the coded video and audio data to the video and audio playback unit 102, and also outputs a data carousel to the data broadcasting browser 108.

The video and audio playback unit 102 to which the coded video and audio data are inputted from the IP network IF/TS demultiplexing unit 106 decodes the coded video and audio data and outputs the decoded video and audio data to the frame composition processing unit 103. The frame composition processing unit 103 composites the video and the audio which are inputted thereto, and outputs the composite video and audio to the monitor and speaker 104. The monitor and speaker 104 provides the video and audio of the service specified by the user by playing back the composite video and audio which are inputted thereto.

On the other hand, the data broadcasting browser 108 to which the data carousel is inputted from the IP network IF/TS demultiplexing unit 106 extracts a data broadcasting content from the control information of the data carousel, and expands the descriptions of the content according to a BML document of this data broadcasting content. First, when the BML document has a procedure description, the data broadcasting browser hands over this procedure description to the procedure description processing unit 109. The procedure description processing unit 109 prepares objects, arranges these objects according to a style description, and outputs the arrangement results to the frame composition processing unit 103. The frame composition processing unit 103 composites the video and the audio which are inputted thereto and outputs the composite video and audio to the monitor and speaker 104, and the monitor and speaker 104 provides the video and audio of the service specified by the user by playing back the composite video and audio which are inputted thereto.

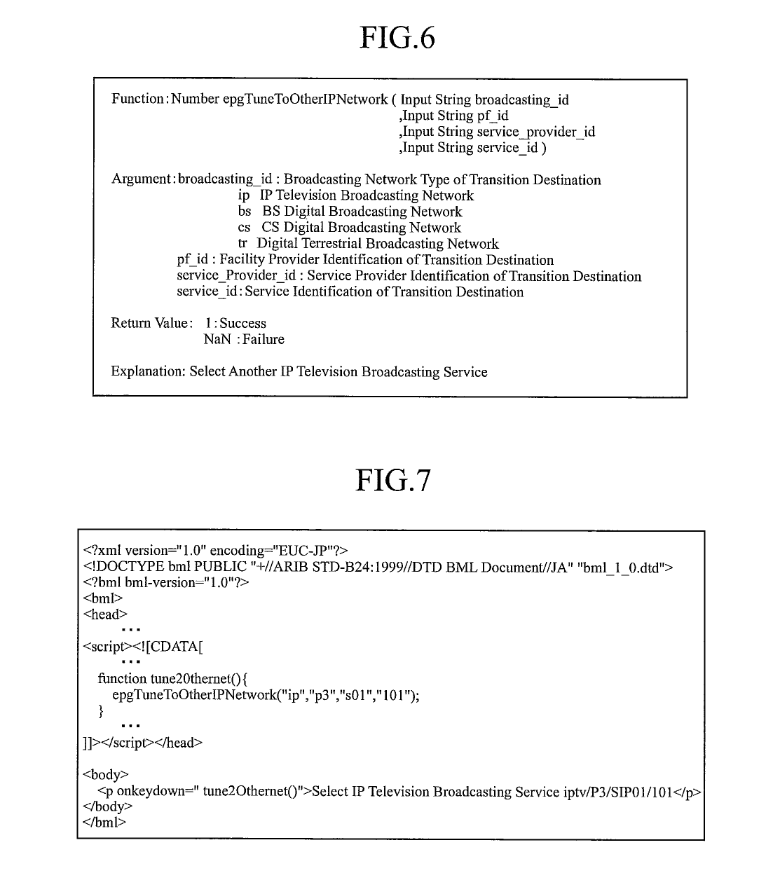

The procedure description processing unit 109 analyzes the descriptive contents of the procedure description delivered thereto, and executes the procedure description at a timing specified. Hereafter, an explanation of an operation according to the description of the BML document of the data broadcasting content of ip/P1/BS01/101 will be made with reference to FIGS. 6 and 7.

FIG. 6 is a view showing an example of the procedure description in accordance with Embodiment 1 of the present invention, and shows the descriptive contents of a procedure description for making a request to select a different IP television broadcasting service (referred to as a procedure description A from here on). FIG. 7 is a view showing an example of the BML document including the procedure description of FIG. 6.

A button showing “Selection of IP broadcasting service ip/P3/SIP01/101” is presented in the playback screen of the digital broadcasting receiver 10 on the basis of the BML document shown in FIG. 7. When the user inputs an “enter” key for the button by using the remote control 11, the infrared IF 101 checks the input branch table and notifies the data broadcasting browser 108 that the enter key has been inputted. The data broadcasting browser 108 transfers the notification to the procedure description processing unit 109, reads the procedure description A as a process at the time when the button is pushed down, and outputs the procedure description to the IP broadcast network transition command IF processing unit 110.

The IP broadcast network transition command IF processing unit 110 inquires of the IP broadcast network channel selection managing unit 111 whether or not the service of ip/P3/SIP01/101 which is an argument can be received, and, when the service can be received, makes a request of the IP broadcast network channel selection managing unit 111 to make a channel selection of the service of ip/P3/SIP01/101. The IP broadcast network channel selection managing unit 111 makes a channel selection of the service by following the broadcasting network identification=IP television broadcasting, the broadcasting facility identification=P3, the service providing means identification=SIP01, and the service identification=101 from the IP broadcast network channel selection management data, like in the case of the channel selection operation from the device managing unit 105 by using the remote control 11, and carries out playback of the service.

As mentioned above, the digital broadcasting receiver in accordance with this Embodiment 1 is configured in such a way as to provide a broadcasting network identifier, a broadcasting facility identifier, a service providing means identifier, and a service identifier when specifying a service for each distribution service, even if broadcast programs provided by a BS/CS service, a digital terrestrial service, and an IP television broadcasting service are the same as one another, or their service identifiers are the same as one another, the digital broadcasting receiver in accordance with this Embodiment 1 can discriminate them from one another by identifying each broadcasting network from which it receives a service.

Furthermore, because the digital broadcasting receiver in accordance with present Embodiment 1 is configured in such a way as to include the procedure description unit for executing a procedure description included in a data broadcasting content, the digital broadcasting receiver in accordance with present Embodiment 1 can implement a channel selection of one of all broadcasting services by specifying a desired broadcast content by using its identifiers.

In above-mentioned Embodiment 1, the example of making a channel selection of an IP television broadcasting service in the same broadcasting network from a data broadcasting content of a BS redistribution service is shown. The digital broadcasting receiver can alternatively make a channel selection of an arbitrary IP broadcasting service from a data broadcasting content of any one of all broadcasting services. For example, in a case in which the digital broadcasting receiver can directly receive a BS original broadcast, the digital broadcasting receiver can make a channel selection of an IP broadcasting service from a data broadcasting content of a BS original broadcast.

### Embodiment 2

In above-mentioned Embodiment 1, the configuration for selecting another IP broadcasting service in an IP network is shown. In contrast, in accordance with this Embodiment 2, a configuration for searching for and selecting an identical service, which is a redistribution destination, from an original broadcasting service is shown.

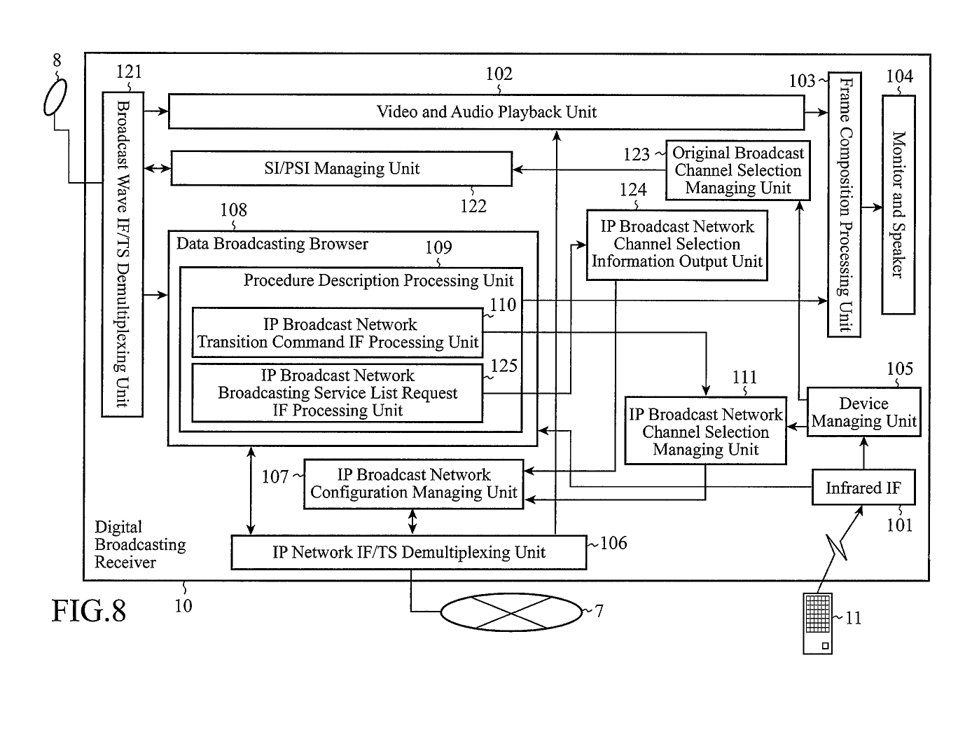

FIG. 8 is a block diagram showing the configuration of a digital broadcasting receiver in accordance with Embodiment 2 of the present invention. Hereafter, the same components as those of the digital broadcasting system in accordance with Embodiment 1 are designated by the same reference numerals as those used in Embodiment 1, and the explanation of the components will be omitted or simplified hereafter.

As shown in FIG. 8, a broadcast wave IF/TS demultiplexing unit 121, an SI/PSI managing unit 122, an original broadcast channel selection managing unit (a broadcast wave network channel selection managing unit) 123, an IP broadcast network channel selection information output unit 124, and an IP broadcast network broadcasting service list request IF processing unit 125 are newly added to the digital broadcasting receiver 10. The broadcast wave IF/TS demultiplexing unit 121 demultiplexes a TS to output SI/PSI information. The SI/PSI managing unit 122 acquires channel selection information about all broadcasting services. The original broadcast channel selection managing unit 123 selects a desired broadcasting service by specifying its identifiers. The IP broadcast network channel selection information output unit 124 outputs, as the identifiers, an IP broadcasting service list. The IP broadcast network broadcasting service list request IF processing unit 125 is built in a data broadcasting browser 108, and makes a request for the IP broadcasting service list.

Next, the operation of this digital broadcasting receiver 10 will be explained. In the following explanation of the operation, a case in which the digital broadcasting receiver acquires a list of services currently being broadcast in an IP broadcast network from a data broadcasting content of a BS original broadcasting service, and searches for and selects the same service identification which is redistributed will be explained. It is assumed that the BS original broadcasting service from which the digital broadcasting receiver makes a transition has a broadcasting network identification=bs, an original network identification=BS01, and a service identification=101, and the BS original broadcasting service will be described as bs/BS01/101 hereafter. Similarly, it is assumed that the IP broadcasting service to which the digital broadcasting receiver makes a transition has a broadcasting network identification=ip, a broadcasting facility identification=P1, a service providing means identification=BS01, and a service identification=101, and the IP broadcasting service will be described as ip/P1/BS01/101 hereafter. The configuration of the digital broadcasting system is the same as the configuration shown in FIG. 1, and it is assumed that the digital broadcasting system uses a BS/CS digital receiving antenna 8.

When electric power is supplied to the digital broadcasting receiver 10 via a remote control 11, a device managing unit 105 carries out an initialization process at the time when the power supply of the digital broadcasting receiver is switched on, like in the case of above-mentioned Embodiment 1, and also outputs an initialization command to the original broadcast channel selection managing unit 123. The original broadcast channel selection managing unit 123 commands the SI/PSI managing unit 122 to acquire channel selection information about receivable BS original broadcasting services. The SI/PSI managing unit 122 selects one frequency from a frequency table in which a correspondence between all broadcasting services and BS digital broadcasting wave frequencies is provided in advance, and commands the broadcast wave IF/TS demultiplexing unit 121 to start receiving a TS of the selected frequency and output SI/PSI information.

The broadcast wave IF/TS demultiplexing unit 121 receives a signal of the specified frequency, and extracts a TS from the signal and demultiplexes the TS to output SI/PSI information. The SI/PSI managing unit 122 extracts all stations' SIs from the NIT of the SI information, acquires pieces of channel selection information about all the broadcasting services, each channel selection information including an original network identification, a TS identification, a service identification, and stores, as BS original broadcast channel selection management data, the pieces of channel selection information therein. The original broadcast channel selection managing unit 123 commands the SI/PSI managing unit 122 to acquire CS original broadcasting service channel selection information, and the SI/PSI managing unit 122 acquires all the stations' SIs from a TS of a frequency currently being broadcast, as in the case of receiving a BS original broadcast, and stores, as CS original broadcasting service channel selection management data, all the stations' SIs therein.

The original broadcast channel selection managing unit 123 further commands the SI/PSI managing unit 122 to acquire digital terrestrial original broadcasting service channel selection information. The SI/PSI managing unit 122 checks to see whether it can select each frequency in a frequency table including all the frequencies used in the whole country, acquires each station's SI from a TS transmitted at a selected frequency, and stores, as digital terrestrial original broadcasting service channel selection management data, each station's SI therein. The above-mentioned processing is carried out at each of all target frequencies. The acquisition of each of the pieces of broadcasting service channel selection management data can be carried out only at a frequency corresponding to area information which is separately set up for the digital broadcasting receiver 10.

Next, when the BS original broadcasting service (the service identification=101) is selected via the remote control 11, an infrared IF 101 checks an input branch table and then outputs a channel selection command for selecting the BS original broadcasting service (the service identification=101) to the device managing unit 105. The device managing unit 105 outputs a command for selecting the BS original broadcasting service to the SI/PSI managing unit 122 via the original broadcast channel selection managing unit 123 on the basis of broadcasting network identification=bs.

The SI/PSI managing unit 122 checks to see whether or not the broadcasting service of “bs/BS01/101” is currently being broadcast from the BS original broadcast channel selection management data, and, when the broadcasting service is currently being broadcast, notifies a start of reception of the broadcasting service to the original broadcast channel selection managing unit 123, and also acquires the channel selection information about the broadcasting service stored in the BS original broadcast channel selection management data, acquires an applicable frequency from the frequency table and the service identification of the channel selection information, and further acquires the TS identification of the broadcasting service. The SI/PSI managing unit 122 further outputs both a channel selection command with the specification of the frequency and a PSI information acquisition command with the specification of the TS identification to the broadcast wave IF/TS demultiplexing unit 121.

The broadcast wave IF/TS demultiplexing unit 121 extracts a TS from a signal of the received specified frequency and demultiplexes the TS, and outputs PSI information corresponding to the TS identification to the SI/PSI managing unit 122. The SI/PSI managing unit 122 acquires a plurality of PIDs of mono media data from the acquired PSI information, and notifies a start of reception of these mono media data to the broadcast wave IF/TS demultiplexing unit 121. The broadcast wave IF/TS demultiplexing unit 121 outputs coded video and audio data to a video and audio playback unit 102, and also outputs a data carousel to the data broadcasting browser 108.

The video and audio playback unit 102 to which the coded video and audio data are inputted from the IP network IF/TS demultiplexing unit 106 decodes the coded video and audio data and outputs the decoded video and audio data to a frame composition processing unit 103. The frame composition processing unit 103 composites the video and the audio which are inputted thereto, and outputs the composite video and audio to a monitor and speaker 104. The monitor and speaker 104 provides the video and audio of the service specified by the user by playing back the composite video and audio which are inputted thereto.

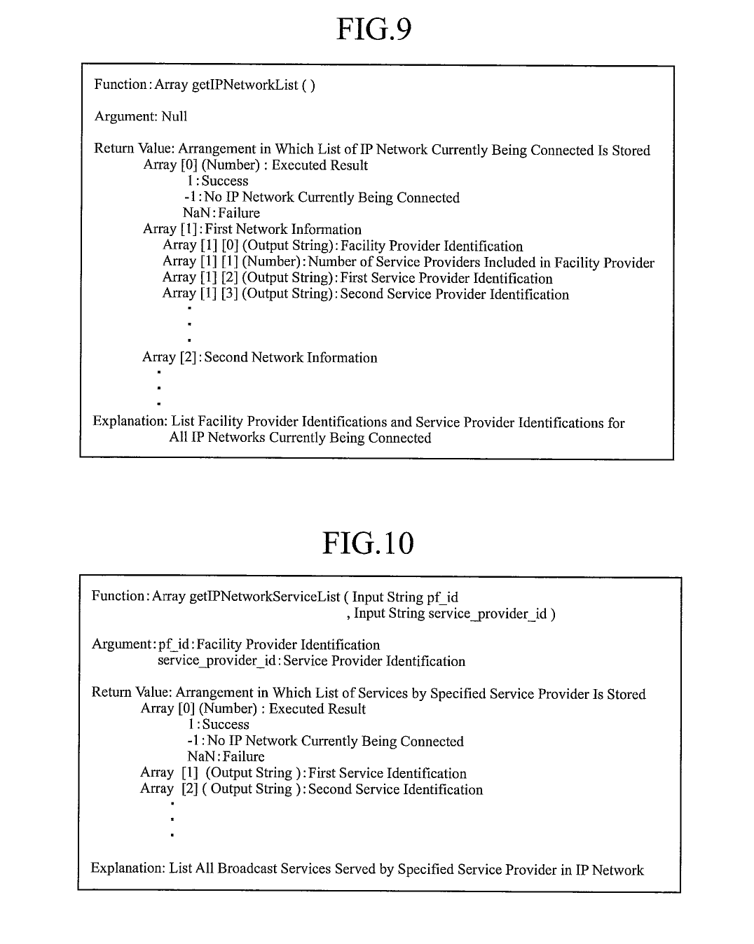

On the other hand, a procedure description processing unit 109 to which a procedure description is inputted according to the same process as that shown in Embodiment 1 analyzes the descriptive contents of the procedure description and executes the procedure description at a timing specified. Hereafter, an explanation of an operation according to the description of a BML document of the data broadcasting content of ip/P1/BS01/101 will be made with reference to FIGS. 6 and 7. FIG. 6 shows the descriptive contents of a procedure description A, FIG. 9 is a view showing an example of a procedure description in accordance with Embodiment 2 of the present invention, and shows the descriptive contents of a procedure description for acquiring a list of IP networks currently being connected (referred to as a procedure description B from here on), and FIG. 10 is a view showing an example of a procedure description in accordance with Embodiment 2 of the present invention, and shows the descriptive contents of a procedure description for acquiring a list of IP network services (referred to as a procedure description C from here on). FIG. 11 is a view showing an example of the BML document including the procedure descriptions of FIGS. 6, 9 and 10.

A button showing “Selection of the same channel for IP redistribution” is presented in the playback screen of the digital broadcasting receiver 10. When the user inputs an “enter” key for the button by using the remote control 11, the infrared IF 101 checks the input branch table and notifies the data broadcasting browser 108 that the enter key has been inputted. The data broadcasting browser 108 transfers the notification to the procedure description processing unit 109, reads the procedure description B as a process at the time when the button is pushed down, and outputs the procedure description to the IP broadcast network broadcasting service list request IF processing unit 125.

The IP broadcast network broadcasting service list request IF processing unit 125 makes a request of the IP broadcast network configuration managing unit 107 for the IP broadcast network broadcasting service list via the IP broadcast network channel selection information output unit 124. The IP broadcast network configuration managing unit (a service searching processing unit) 107 outputs, as the list, all broadcasting service identifications in the service providing means identification which is specified from the IP broadcast network channel selection management data to send the list back to the IP broadcast network broadcasting service list request IF processing unit 125 via the IP broadcast network channel selection information output unit 124. The procedure description processing unit 109 checks to see that the service identification of the broadcasting service currently being watched by the user is included in the list on the basis of the results of the execution of the procedure description C, and reads the procedure description A. After that, the digital broadcasting receiver carries out the same channel selection operation as that shown in Embodiment 1 to playback the service.

As mentioned above, the digital broadcasting receiver in accordance with this Embodiment 2 is configured in such a way as to include the IP broadcast network broadcasting service list request IF processing unit for making a request for an IP broadcasting service list, and the IP broadcast network channel selection information output unit for outputting, as the IP broadcast network broadcasting service list, all broadcasting facility identifications and all service providing means identifications stored in IP broadcast network channel selection management data. Therefore, the digital broadcasting receiver in accordance with this Embodiment can make a channel selection of the same broadcast service which is redistributed via the IP network from a data broadcasting content of an original broadcast service.

In above-mentioned Embodiment 2, a content from which the same broadcast service as a broadcast service currently being watched by the user is selected is shown. The digital broadcasting receiver can alternatively make a selection of a different broadcast service, such as acquisition and channel selection of channel selection information about all broadcast services on the IP network from a BS original broadcast.

Furthermore, in above-mentioned Embodiment 2, the example in which two procedure descriptions are separately provided when acquiring an IP network broadcast service list is shown. The digital broadcasting receiver can be alternatively configured in such a way as to carry out acquisition of an IP network broadcast service list by providing only one procedure description. The digital broadcasting receiver can be alternatively configured in such a way as to carry out the search while narrowing the search by using a combination of a broadcasting facility identification, a service providing means identification, and a service identification. Especially, when making a search for the same broadcast service, the digital broadcasting receiver can provide a procedure description for narrowing the search by using both of an original network identification and a service identification which it uses to identify a broadcast service on the side of broadcast waves, or by using the original network identification and the service identification in turn.

Furthermore, in above-mentioned Embodiment 2, the configuration for searching for and selecting the same broadcast service which is redistributed and broadcast according to the descriptions of a data broadcasting content of an original broadcast is shown. However, the digital broadcasting receiver is intended not only for channel selection of a fixed channel selection destination service but also for channel selection of one of all possible broadcast services. The same goes for all the embodiments which will be mentioned below.

### Embodiment 3

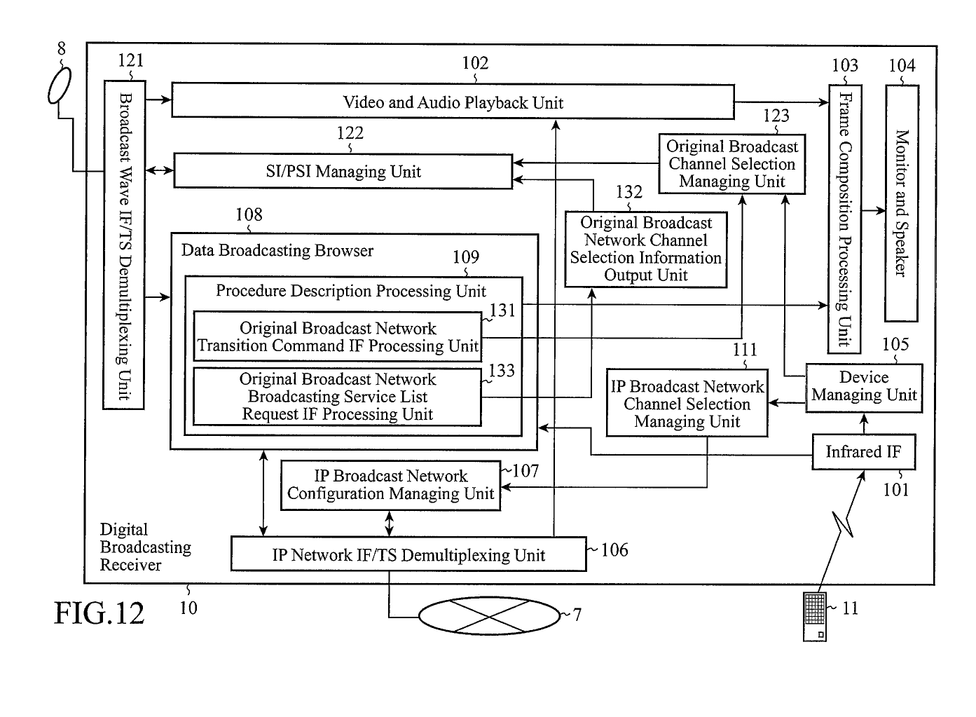

In above-mentioned Embodiment 2, the configuration for selecting an IP broadcasting service from a data broadcasting contents of an original broadcasting service is shown. In contrast, in accordance with this Embodiment 3, a configuration for selecting an original broadcasting service from a data broadcasting content of an IP broadcasting service is shown. FIG. 12 is a block diagram showing the configuration of a digital broadcasting receiver in accordance with Embodiment 3 of the present invention. Hereafter, the same components as those of the digital broadcasting systems in accordance with Embodiments 1 and 2 are designated by the same reference numerals as those used in Embodiments 1 and 2, and the explanation of the components will be omitted or simplified hereafter.

The digital broadcasting receiver 10 shown in FIG. 12 includes an original broadcast network transition command IF processing unit (a broadcast wave network broadcasting channel selection IF processing unit) 131 and an original broadcast network broadcasting service list request IF processing unit (a broadcast wave network broadcasting service list request IF processing unit) 133, instead of the IP broadcast network transition command IF processing unit 110 and the IP broadcasting service list request IF processing unit 125, which are shown in FIG. 8 of Embodiment 2. The descriptions of processes carried out by them are the same as those shown in Embodiment 2. Furthermore, instead of the IP broadcast network channel selection information output unit 124, an original broadcast network channel selection information output unit (a broadcast wave network channel selection information output unit) 132 is disposed. This original broadcast network channel selection information output unit 132 outputs, as a service list, identifiers of each of all broadcasting services currently being broadcast.

Next, the operation of this digital broadcasting receiver 10 will be explained. In the following explanation of the operation, a case in which the digital broadcasting receiver acquires a list of services currently being broadcast via an original broadcast network from a data broadcasting content of a BS redistribution broadcasting service, and searches for a service identification and refers to mono media data of the same service. The BS redistribution broadcasting service from which the digital broadcasting receiver makes a transition is described as “ip/P1/BS01/101”, and the BS original broadcasting service to which the digital broadcasting receiver makes a transition is described as “bs/BS01/101”. The configuration of the digital broadcasting system is the same as the configuration shown in FIG. 1, and it is assumed that the digital broadcasting system uses a BS/CS digital receiving antenna 8.

When electric power is supplied to the digital broadcasting receiver 10 via a remote control 11, the digital broadcasting receiver 10 carries out the same initialization processing as that shown in Embodiment 2. Furthermore, the BS redistribution service (the service identification=101) is selected via the remote control 11, and the digital broadcasting receiver 10 plays back video, audio and data of the BS redistribution service.

Next, an explanation of operation based on the description of the data broadcasting content BML document of ip/P1/BS01/101 will be made with reference to FIGS. 13, 14 and 15. FIG. 13 is a view showing an example of a procedure description in accordance with Embodiment 3 of the present invention, and shows the descriptive contents of the procedure description for acquiring a list of original broadcast networks currently being connected (referred to as a procedure description D from here on). FIG. 14 is a view showing an example of a procedure description in accordance with Embodiment 3 of the present invention, and shows the descriptive contents of the procedure description for making a request to select a broadcasting service in a different original broadcast network (referred to as a procedure description E from here on). FIG. 15 is a view showing an example of a BML document including the procedure descriptions shown in FIGS. 13 and 14.

A button showing “Selection of the same channel of original broadcast” is presented in the playback screen of the digital broadcasting receiver 10. When the user inputs an “enter” key for the button by using the remote control 11, the infrared IF 101 checks the input branch table and notifies the data broadcasting browser 108 that the enter key has been inputted. The data broadcasting browser 108 transfers the notification to the procedure description processing unit 109, reads the procedure description D as a process at the time when the button is pushed down, and outputs the procedure description to the original broadcast network broadcasting service list request IF processing unit 133.

The original broadcast network broadcasting service list request IF processing unit 133 makes a request of the SI/PSI managing unit 122 for a list of original broadcast network broadcasting services via the original broadcast network channel selection information output unit 132. The SI/PSI managing unit 122 outputs, as an original broadcast network broadcasting service list, original broadcast channel selection management data about BS/CS and digital terrestrial in units of each broadcasting network identification, and sends the original broadcast network broadcasting service list back to the original broadcast network broadcasting service list request IF processing unit 133 via the original broadcast network channel selection information output unit 132.

The procedure description processing unit 109 searches for broadcasting services whose broadcasting network identification is “bs” from among the list which is the result of execution of the procedure description D, and further searches for a broadcasting service whose service identification is “101” from the search results. When the procedure description E is called with the broadcasting service which is the search result being set as an argument, the original broadcast network transition command IF processing unit 131 gives makes a request of the original broadcast channel selection managing unit 123 to select the original broadcasting service. As a result, the original broadcasting service is selected and playback of the BS original broadcasting service is carried out.

As mentioned above, the digital broadcasting receiver in accordance with this Embodiment 3 is configured in such a way as to include the original broadcast network broadcast service list request IF processing unit for making a request for an original broadcast network broadcasting service list, and the original broadcast network channel selection information output unit for outputting, as the original broadcast network broadcasting service list, original broadcast channel selection management data for each broadcasting network type. Therefore, the digital broadcasting receiver in accordance with this Embodiment can make a channel selection of an original broadcast from a data content of a broadcasting service on an IP network.

In above-mentioned Embodiment 3, the configuration for outputting a list at one time is shown as the procedure description for acquiring a list of original broadcast networks currently being connected. As an alternative, the digital broadcasting receiver can be configured in such a way as to specify broadcasting network types as an argument of the procedure description, and output a list of the broadcasting network types, or to divide the procedure description regarding the list output request into two portions and output a desired broadcast service list.

### Embodiment 4

In above-mentioned Embodiments 1 to 3, the configuration for selecting a different broadcasting service beyond the limits of a certain type of broadcasting network according to a command from a data broadcasting content of a broadcasting service is shown. In contrast, in accordance with this Embodiment 4, a configuration for referring to a mono medium included in broadcast data of a different broadcasting service beyond the limits of a certain type of broadcasting network from a data broadcasting content currently being watched by a use will be shown.

FIG. 16 is a block diagram showing the configuration of a digital broadcasting receiver in accordance with Embodiment 4 of the present invention. Hereafter, the same components as those of the digital broadcasting system in accordance with Embodiments 1 and 2 are designated by the same reference numerals as those used in Embodiments 1 and 2, and the explanation of the components will be omitted or simplified hereafter.

The digital broadcasting receiver 10 shown in FIG. 16 includes an element and attribute description processing unit (an element attribute description processing unit) 141, instead of the procedure description processing unit 109 shown in FIG. 8 of Embodiment 2. The element and attribute description processing unit 141 are built in a data broadcasting browser 108, and describes elements and attributes which are to be included in a data broadcasting content. Furthermore, an IP broadcast network reference command IF processing unit (an IP broadcast network reference IF processing unit) 142 is built in the element and attribute description processing unit 141, and issues a command for referring to a broadcasting service specified by its identifiers. In addition, instead of the IP broadcast network channel selection information output unit 124, an IP broadcast network reference managing unit 143 is disposed. The IP broadcast network reference managing unit 143 specifies each identifier to refer to some broadcast data included in a desired broadcasting service.

Next, the operation of this digital broadcasting receiver 10 will be explained. In the following explanation of the operation, a case in which the digital broadcasting receiver refers to video and audio of an IP broadcasting service in a data broadcasting content of a BS original broadcasting service currently being watched by a user, i.e. a case in which the digital broadcasting receiver presents video and audio which it refers to in a screen in which a data broadcasting content of a BS original broadcasting service currently being watched by a user is being played back will be explained. The BS original broadcasting service from which the digital broadcasting receiver makes a transition is described as “bs/BS01/101”, and the IP broadcasting service to which the digital broadcasting receiver makes a transition is described as “ip/P3/SIP01/101”. The configuration of the digital broadcasting system is the same as the configuration shown in FIG. 1, and it is assumed that the digital broadcasting system uses a BS/CS digital receiving antenna 8.

While electric power is first supplied to the digital broadcasting receiver 10 via a remote control 11 and initialization processing is carried out, like in the case of above-mentioned Embodiments 1 to 3, the BS original broadcasting service from which the digital broadcasting receiver makes a transition is selected via the remote control 11, and video, audio, and a data broadcast of the BS original broadcasting service are played back by the digital broadcasting receiver 10.

Next, an explanation of the operation of the digital broadcasting receiver 10 will be made according to the descriptions of a BML document. FIG. 17 is a view showing an example of a BML document in accordance with Embodiment 4 of the present invention, and shows a BML document of the data broadcasting content of bs/BS01/101. As shown in FIG. 17, an object element has a data attribute which is described in the following format: “arib:// broadcasting network identification/broadcasting facility identification.service providing means identification.service identification/”. When the data broadcasting browser 108 finds an object element in the data broadcasting content while carrying out a process of playing back the data broadcasting content, the data broadcasting browser 108 notifies the element and attribute description processing unit 141 that it has found an object element. The element and attribute description processing unit 141 analyzes the object element, judges that its data attribute shows a command for referring to a mono medium corresponding to a broadcasting network identification in the IP broadcast network, and then commands the IP broadcast network reference command IF processing unit 142 to perform a certain process.

The IP broadcast network reference command IF processing unit 142 checks with an IP broadcast network configuration managing unit 107 via the IP broadcast network reference managing unit 143 for whether or not the broadcasting service is currently being broadcast and whether or not the broadcasting service includes application/X-arib-mpeg2-tts (indicating video and audio as a mono medium) which is specified as a type attribute. When, as a result of the checking, determining that the broadcasting service is currently being broadcast and includes application/X-arib-mpeg2-tts, the IP broadcast network reference command IF processing unit commands the IP broadcast network reference managing unit 143 to refer to the mono medium. The IP broadcast network reference managing unit 143 issues a command with specification of video and audio for referring to the mono medium of the broadcasting service ip/P3/SIP01/101 to an IP network IF/TS demultiplexing unit 106 via the IP broadcast network configuration managing unit 107. The IP network IF/TS demultiplexing unit 106 makes a channel selection of the broadcasting service, and outputs only the coded video and audio data which is the specified mono medium to a video and audio playback unit 102.

Furthermore, the data broadcasting browser 108 outputs the video and the audio according to a presentation position and a presentation timing which are described in the data broadcasting content. As a result, in a screen in which the data broadcasting content of the BS original broadcasting service is being played back, the video and audio of the IP broadcasting service can be displayed while they can be referred to.

As mentioned above, because the digital broadcasting receiver in accordance with this Embodiment 4 is configured in such a way as to include the element and attribute description processing unit for executing element and attribute descriptions included in a data broadcasting content, the digital broadcasting receiver in accordance with this Embodiment 4 can inherently refer to a mono medium included in the data broadcasting content. Therefore, a data broadcasting content which enables reference to a mono medium beyond the limits of a certain type of broadcasting network can be broadcast.

In above-mentioned Embodiment 4, the configuration for inherently referring to a mono medium included in a data broadcasting content according to element and attribute descriptions is explained. The digital broadcasting receiver in accordance with this Embodiment 4 can be alternatively configured in such away as to inherently refer to a mono medium currently being data-broadcast according to a procedure description having the same function.

### Embodiment 5

In above-mentioned Embodiment 4, the configuration for referring to a mono medium included in broadcast data of an IP broadcasting service from a data broadcasting content of an original broadcasting service currently being watched by the user is shown. In contrast, in accordance with this Embodiment 5, a configuration for referring to a mono medium included in broadcast data of an original broadcasting service from a data broadcasting content of an IP broadcasting service currently being watched by the user will be shown. FIG. 18 is a block diagram showing the configuration of a digital broadcasting receiver in accordance with Embodiment 5 of the present invention. Hereafter, the same components as those of the digital broadcasting system in accordance with Embodiments 1 to 4 are designated by the same reference numerals as those used in Embodiments 1 to 4, and the explanation of the components will be omitted or simplified hereafter.

The digital broadcasting receiver 10 shown in FIG. 18 includes an original broadcast network reference command IF processing unit (a broadcast wave network reference IF processing unit) 151 and an original broadcast network reference managing unit (a broadcast wave network reference managing unit) 152, instead of the IP broadcast network reference command IF processing unit 142 and IP broadcast network reference managing unit 143 which are shown in FIG. 16 of Embodiment 4. The original broadcast network reference command IF processing unit 151 is built in an element and attribute description processing unit 141 of a data broadcasting browser 108, and issues a command for referring to a broadcasting service specified by its identifiers. The original broadcast network reference managing unit 152 specifies identifiers to refer to some broadcast data included in a desired broadcasting service.

Next, the operation of this digital broadcasting receiver 10 will be explained. In the following explanation of the operation, a case in which the digital broadcasting receiver refers to video and audio of a BS original broadcasting service in a data broadcasting content of an IP broadcasting service currently being watched by the user will be explained. The IP broadcasting service from which the digital broadcasting receiver makes a transition is described as “ip/P3/SIP01/101”, and the BS original broadcasting service to which the digital broadcasting receiver makes a transition is described as “bs/BS01/101 (TS identification=703)”. The configuration of the digital broadcasting system is the same as the configuration shown in FIG. 1, and it is assumed that the digital broadcasting system uses a BS/CS digital receiving antenna 8.

While electric power is first supplied to the digital broadcasting receiver 10 via a remote control 11 and an initialization process is carried out, like in the case of above-mentioned Embodiments 1 to 4, the IP broadcasting service from which the digital broadcasting receiver makes a transition is selected via the remote control 11, and video, audio and a data broadcast of the IP broadcasting service are played back by the digital broadcasting receiver 10.

Next, an explanation of the operation of the digital broadcasting receiver 10 will be made on the basis of the descriptions of a BML document. FIG. 19 is a view showing an example of a BML document in accordance with Embodiment 5 of the present invention, and shows a BML document of the data broadcasting content of ip/P3/SIP01/101. As shown in FIG. 19, an object element has a data attribute which is described in the following format: “arib:// broadcasting network identification/original network identification.TS identification.service identification/”. When the data broadcasting browser 108 finds an object element in the data broadcasting content while carrying out a process of playing back the data broadcasting content, the data broadcasting browser 108 notifies the element and attribute description processing unit 141 that it has found an object element. The element and attribute description processing unit 141 analyzes the object element, judges that its data attribute shows a command for referring to a mono medium corresponding to a broadcasting network identification in the original broadcast network, and then commands the original broadcast network reference command IF processing unit 151 to perform a certain process.

The original broadcast network reference command IF processing unit 151 checks with an SI/PSI managing unit 122 via the original broadcast network reference managing unit 152 for whether or not the broadcasting service is currently being broadcast and whether or not the broadcasting service includes application/X-arib-mpeg2-tts (indicating video and audio as a mono medium) which is specified as a type attribute. When, as a result of the checking, determining that the broadcasting service is currently being broadcast and includes application/X-arib-mpeg2-tts, the original broadcast network reference command IF processing unit commands the original broadcast network reference managing unit 152 to refer to the mono medium.

The original broadcast network reference managing unit 152 issues a command with specification of video and audio for referring to the mono medium of the broadcasting service bs/BS01/101 to a broadcast wave IF/TS demultiplexing unit 121 via the SI/PSI managing unit 122. The broadcast wave IF/TS demultiplexing unit 121 makes a channel selection of the broadcasting service, and outputs only the coded video and audio data which is the specified mono medium to a video and audio playback unit 102. Furthermore, the data broadcasting browser 108 outputs the video and the audio according to a presentation position and a presentation timing which are described in the data broadcasting content. As a result, in a screen in which the data broadcasting content of the IP broadcasting service is being played back, the video and audio of the BS original broadcasting service can be displayed while they can be referred to.

As mentioned above, because the digital broadcasting receiver in accordance with this Embodiment 5 is configured in such a way as to include the element and attribute description processing unit for executing element and attribute descriptions included in a data broadcasting content, the digital broadcasting receiver in accordance with this Embodiment 5 can inherently refer to a mono medium included in the data broadcasting content. Therefore, a data broadcasting content which enables reference to a mono medium beyond the limits of a certain type of broadcasting network can be broadcast.

In above-mentioned Embodiment 5, the configuration for inherently referring to a mono medium included in a data broadcasting content according to element and attribute descriptions is explained. The digital broadcasting receiver in accordance with this Embodiment 5 can be alternatively configured in such away as to inherently refer to a mono medium currently being data-broadcast according to a procedure description having the same function.

### Embodiment 6

In above-mentioned Embodiment 4, a case in which the digital broadcasting receiver is connected to one IP broadcasting network is shown. In contrast, in this Embodiment 6, a case in which a digital broadcasting receiver is connected to a CDN (Contents Delivery Network) which is a plurality of IP broadcasting networks is shown.

For an IP broadcasting network, there is provided a service for unicasting a video and audio TTS (Time stamped TS) resource selected by a viewer, which is called a VOD (Video On Demand) function. In order to implement this VOD function, resource files, such as a video and audio TTS resource file and a license related information description file, are disposed. The VOD function is implemented by using a VOD playback control file in which the URIs of those resource files are collectively described. In an IP broadcasting network in which an object element has a single data attribute, playback of a VOD can be carried out by specifying the URI of a VOD playback control file, and the URI is described as “http://” or “https://” and a file path starting from a domain name following “http://” or “https://”. In order to show that an object element is a VOD playback control file, for example, “application/X-arib-contentPlayControl” is specified as the type attribute of the object element.

In order to solve a domain name, a protocol defined by IETF RFC1034 “DOMAIN NAMES—CONCEPTS AND FACILITIES”, IETF RFC1035 “DOMAIN NAMES—IMPLEMENTATION AND SPECIFICATION”, and IETF RFC3646 “DNS Configuration options for Dynamic Host Configuration Protocol for IPv6” (DHCPv6) is used.

FIG. 20 is a view showing the configuration of a digital broadcasting receiver in accordance with Embodiment 6 of the present invention and a broadcasting network connected to the digital broadcasting receiver. In addition to the components of the digital broadcasting receiver in accordance with Embodiment 4 shown in FIG. 16, the digital broadcasting receiver 10 shown in FIG. 20 includes a VOD playback control unit 153, a domain name acquiring unit 154 built in an element and attribute description processing unit 141 of a data broadcasting browser 108, an IP network IF/TS demultiplexing unit A155 in which a DNS-based domain name solution processing unit A156 is built in, and an IP network IF/TS demultiplexing unit B157 in which a DNS-based domain name solution processing unit B158 is built in, instead of the IP broadcast network configuration managing unit 107, the IP broadcast network channel selection managing unit 111, the IP broadcast network reference command IF processing unit 142, and the IP broadcast network reference managing unit 143. The digital broadcasting receiver 10 is connected to a CDN-A 159 and a CDN-B 160.

Next, the operation of this digital broadcasting receiver 10 will be explained. In the following explanation of the operation, a case in which the digital broadcasting receiver refers to video and audio of an IP broadcasting service in a data broadcasting content of a BS original broadcasting service currently being watched by a user, i.e. a case in which the digital broadcasting receiver presents video and audio which it has referred to in a screen in which a data broadcasting content of a BS original broadcasting service currently being watched by a user is being played back will be explained. The VOD playback control file which is the reference destination and its domain exist only in the CDN-B 160 of the CDN identification, the domain name is “hoo.net”, and the URI of the VOD playback control file is “http://hoo.net/video/1/1.cpc”. It is assumed that a BS/CS digital receiving antenna 8 is used for reception of the BS original broadcasting service from which the digital broadcasting receiver makes a transition.

While electric power is first supplied to the digital broadcasting receiver 10 via a remote control 11 and an initialization process is carried out, like in the case of above-mentioned Embodiment 4, the BS original broadcasting service from which the digital broadcasting receiver makes a transition is selected via the remote control 11, and video, audio and a data broadcast of the BS original broadcasting service are played back by the digital broadcasting receiver 10.

Next, an explanation of the operation of the digital broadcasting receiver 10 will be made on the basis of the descriptions of a BML document. FIG. 21 is a view showing an example of a BML document in accordance with Embodiment 6 of the present invention, and shows a BML document of a data broadcasting content included in the BS original broadcasting service. As shown in FIG. 21, an object element has a data attribute which is described in a format of “http://hoo.net/video/1/1.cpc”. When the data broadcasting browser 108 finds an object element in the data broadcasting content while carrying out a process of playing back the data broadcasting content, the data broadcasting browser 108 notifies the element and attribute description processing unit 141 that it has found an object element. The element and attribute description processing unit 141 analyzes the object element, and, when the object element includes a data attribute, commands the domain name acquiring unit 154 to analyze the data attribute.

The domain name acquiring unit 154 extracts “hoo.net” which is a domain name from the character string of the data attribute, and then commands the DNS-based domain name solution processing unit A156 to provide a DNS solution. The DNS-based domain name solution processing unit A156 sends a DNS inquiry about “hoo.net” to the CDN-A 159, though the DNS-based domain name solution processing unit answers the domain name acquiring unit 154 that the DNS-based domain name solution processing unit has not received any reply from the CDN-A 159 and a timeout has occurred, and hence the DNS-based domain name solution processing unit has failed in providing any domain solution.

The domain name acquiring unit 154 then commands the DNS-based domain name solution processing unit B158 to provide a DNS solution. The DNS-based domain name solution processing unit B158 sends a DNS inquiry about “hoo.net” to the CDN-B 160, receives a reply showing the address of the domain from the domain server in this CDN, stores information showing that the domain has been found in the CDN-B 160 therein, and answers the domain name acquiring unit 154 that the DNS-based domain name solution processing unit has succeeded in providing a domain solution.

Next, the element and attribute description processing unit 141 commands the IP network IF/TS demultiplexing unit B157 which has succeeded in providing a domain solution to acquire a file according to the HTTP protocol and by using both the URI described in the data attribute of the object element and the protocol “http://” at the head of the data attribute.

The IP network IF/TS demultiplexing unit B157 replaces the domain name with the address stored in the DNS-based domain name solution processing unit B158, and sends out the HTTP protocol for file acquisition to the CDN-B 160. The CDN-B 160 sends a file at the specified URI back to the digital broadcasting receiver 10 from the server at the address owned thereby, and the IP network IF/TS demultiplexing unit B157 delivers the received file to the element and attribute description processing unit 141.

Because the type attribute of the object element is application/X-arib-contentPlayControl, the element and attribute description processing unit 141 determines that the file acquired with the URI of the data attribute of the object element is a VOD playback control file, and notifies that the IP network IF/TS demultiplexing unit B157 has succeeded in providing a domain solution and also delivers the VOD playback control file to the VOD playback control unit 153.

The VOD playback control unit 153 parses the contents of the VOD playback control file to determine the URI of the TTS resource and the URI of the license related information description file, and commands the IP network IF/TS demultiplexing unit B157 to acquire the required resource files. When a URI which the IP network IF/TS demultiplexing unit B157 is commanded to acquire is a domain name, the IP network IF/TS demultiplexing unit B157 converts the domain name into an address stored in the DNS-based domain name solution processing unit B158, and then carries out the acquisition process. This IP network IF/TS demultiplexing unit B157 acquires the TTS resource from the CDN-B 160, and delivers the TTS resource to a video and audio playback unit 102, so that video and audio are played back.

As mentioned above, because the digital broadcasting receiver in accordance with this Embodiment 6 is configured in such a way as to include the domain name acquiring unit for acquiring a domain name from the character string of a data attribute to issue a command for providing a DNS solution, and the DNS-based domain solution processing unit for making a DNS inquiry of a plurality of CDNs according to the DNS solution command, the digital broadcasting receiver can solve a domain name through the plurality of CDNs according to the DNS protocol.

In above-mentioned Embodiment 6, the example in which the digital broadcasting receiver provides a domain solution through a plurality of CDNs in turn is shown, though all the digital broadcasting receiver has to do is to determine a CDN which has succeeded in finding a domain solution, and therefore the digital broadcasting receiver can cause the plurality of CDNs to find a domain solution simultaneously.

Furthermore, in above-mentioned Embodiment 6, the example in which the digital broadcasting receiver is connected to a plurality of CDNs is shown. As an alternative, the digital broadcasting receiver can be connected to different types of networks to which the digital broadcasting receiver can access according to the IP protocol, and, for example, the different types of networks can be a combination of the Internet and CDNs.

### Embodiment 7

In above-mentioned Embodiment 6, the digital broadcasting receiver which searches through a plurality of CDNs in turn for a domain according to the DNS protocol to determine a CDN is shown. In contrast, in accordance with this Embodiment 7, a digital broadcasting receiver which finds out a domain which matches a specified domain from configuration management information to determine a CDN will be shown.

FIG. 22 is a view showing the configuration of the digital broadcasting receiver in accordance with Embodiment 7 of the present invention and a broadcasting network connected to the digital broadcasting receiver. In addition to the components of the digital broadcasting receiver in accordance with Embodiment 4 shown in FIG. 16, the digital broadcasting receiver 10 shown in FIG. 22 includes a VOD playback control unit 153, a domain name acquiring unit 154 built in an element and attribute description processing unit 141 of a data broadcasting browser 108, an IP network IF/TS demultiplexing unit A155, an IP network IF/TS demultiplexing unit B157, and a configuration-management-information-based domain name searching processing unit 161 built in an IP broadcast network configuration managing unit 107, instead of the IP broadcast network channel selection managing unit 111, the IP broadcast network reference command IF processing unit 142, and the IP broadcast network reference managing unit 143. The digital broadcasting receiver 10 is connected to a CDN-A 159 and a CDN-B 160.

While electric power is first supplied to the digital broadcasting receiver 10 via a remote control 11 and an initialization process is carried out, like in the case of above-mentioned Embodiment 4, a BS original broadcasting service from which the digital broadcasting receiver makes a transition is selected via the remote control 11, and video, audio and a data broadcast of the BS original broadcasting service are played back by the digital broadcasting receiver 10. The IP broadcast network configuration managing unit 107 acquires pieces of configuration management information, which are specified in advance, from all CDNs connected to the digital broadcasting receiver, i.e. the CDN-A 159 and the CDN-B 160 on the basis of the URIs of the pieces of configuration management information.

Next, an explanation of the operation of the digital broadcasting receiver 10 will be made on the basis of the descriptions of a BML document. An example of a BML document in accordance with this Embodiment 7 is shown in FIG. 21, like in the case of Embodiment 6. When the data broadcasting browser 108 finds an object element in a data broadcasting content while carrying out a process of playing back the data broadcasting content, the data broadcasting browser notifies the element and attribute description processing unit 141 that it has found an object element. The element and attribute description processing unit 141 analyzes the object element, and, when the object element includes a data attribute, commands the domain name acquiring unit 154 to analyze the data attribute.

The domain name acquiring unit 154 extracts “hoo.net” which is a domain name from the character string of the data and then commands the configuration-management-information-based domain name searching processing unit 161 to search for the domain name.

The configuration-management-information-based domain name searching processing unit 161 compares the domain name for which the configuration-management-information-based domain name searching processing unit is commanded to search with the domain name described in the portal URI of each configuration management information which it has acquired through the initialization process in turn. The configuration-management-information-based domain name searching processing unit 161 detects and stores a CDN including the domain name which matches the specified domain name therein, and also answers the domain name acquiring unit 154 that the configuration-management-information-based domain name searching processing unit has detected the domain name with the configuration management information on the side of the IP network IF/TS demultiplexing unit B157.

The element and attribute description processing unit 141 commands the IP network IF/TS demultiplexing unit B157 to acquire a file according to the HTTP protocol and by using the protocol “http://” at the head of the data attribute.

The IP network IF/TS demultiplexing unit B157 carries out a DNS-based domain name solution process to store an acquired domain name, and carries out address conversion to send out the HTTP protocol for file acquisition to the CDN-B 160. The CDN-B 160 sends the file at the specified URI back to the digital broadcasting receiver 10 from the server at the address owned thereby, and the IP network IF/TS demultiplexing unit B157 delivers the received file to the element and attribute description processing unit 141.

Because the type attribute of the object element is application/X-arib-contentPlayControl, the element and attribute description processing unit 141 determines that the file acquired with the URI of the data attribute of the object element is a VOD playback control file, and notifies that the IP network IF/TS demultiplexing unit B157 has succeeded in providing a domain solution and also delivers the VOD playback control file to the VOD playback control unit 153.

The VOD playback control unit 153 parses the contents of the VOD playback control file to determine the URI of a TTS resource and the URI of a license related information description file, and commands the IP network IF/TS demultiplexing unit B157 to acquire the required resource files. When a URI which the IP network IF/TS demultiplexing unit B157 is commanded to acquire is a domain name, the IP network IF/TS demultiplexing unit B157 converts the domain name into an address stored and then carries out the acquisition process. This IP network IF/TS demultiplexing unit B157 acquires the TTS resource from the CDN-B 160, and delivers the TTS resource to a video and audio playback unit 102, so that video and audio are played back.

As mentioned above, because the digital broadcasting receiver in accordance with this Embodiment 7 is configured in such away as to include the IP broadcast network configuration managing unit for acquiring pieces of configuration management information from all CDNs connected to the digital broadcasting receiver, the domain name acquiring unit for acquiring a domain name from the character string of a data attribute, and for issuing a command for providing a DNS solution, and the configuration-management-information-based domain name searching processing unit for comparing the domain name for which the configuration-management-information-based domain name searching processing unit is commanded to search with the domain name described in each piece of configuration management information which the IP broadcast network configuration managing unit has acquired, the digital broadcasting receiver can detect the same domain name from the plural pieces of configuration management information to can determine a CDN.

### Embodiment 8

In above-mentioned Embodiment 4, the case in which in order to refer to a mono medium included in broadcast data of an IP broadcasting service from a data broadcasting content of an original broadcasting service currently being watched by a user, the digital broadcasting receiver makes explicit that it is an IP broadcasting service by using a conventional schema is shown. In contrast, in accordance with this Embodiment 8, a new schema is introduced in order to enable reference to a general mono medium resource, which is provided in an IP broadcasting network, from a data broadcasting content of an original broadcasting service currently being watched by a user.

In this Embodiment 8, a case in which a new schema is introduced in order to identify a plurality of CDNs connected to a digital broadcasting receiver 10 will be explained. For example, “ipvod” is introduced and “ipvod://<CDN identification (IP network identification)>/” is shown so that a CDN is identified, and, after that, a file path (name space) used within the CDN is described so that a mono medium in an IP broadcasting service can be referred to from another broadcasting network.

FIG. 23 is a view showing the configuration of the digital broadcasting receiver in accordance with Embodiment 8 of the present invention and a broadcasting network connected to the digital broadcasting receiver. In addition to the components of the digital broadcasting receiver in accordance with Embodiment 4 shown in FIG. 16, the digital broadcasting receiver 10 shown in FIG. 23 includes a VOD playback control unit 153, an IP network IF/TS demultiplexing unit A155, an IP network IF/TS demultiplexing unit B157, and a VOD schema analyzer 162 (a schema analyzer) built in an element and attribute description processing unit 141 of a data broadcasting browser 108, instead of the IP broadcast network configuration managing unit 107, the IP broadcast network channel selection managing unit 111, the IP broadcast network reference command IF processing unit 142, and the IP broadcast network reference managing unit 143. The digital broadcasting receiver 10 is connected to a CDN-A 159 and a CDN-B 160.

Next, the operation of this digital broadcasting receiver 10 will be explained. In the following explanation of the operation, a case in which the digital broadcasting receiver refers to video and audio of an IP broadcasting service in a data broadcasting content of a BS original broadcasting service currently being watched by a user, i.e. a case in which the digital broadcasting receiver presents video and audio which it has referred to in a screen in which a data broadcasting content of a BS original broadcasting service currently being watched by a user is being played back will be explained. A VOD playback control file which is a reference destination exists in the “CDN-B” of the CDN identification, and the URI in the CDN-B is “http://hoo.net/video/1/1.cpc”. Therefore, the URI of this VOD playback control file is described as “ipvod://CDN-B/hoo.net/video/1/1.cpc”. It is assumed that a BS/CS digital receiving antenna 8 is used for reception of the BS original broadcasting service from which the digital broadcasting receiver makes a transition.

While electric power is first supplied to the digital broadcasting receiver 10 via a remote control 11 and an initialization process is carried out, like in the case of above-mentioned Embodiment 4, a BS original broadcasting service from which the digital broadcasting receiver makes a transition is selected via the remote control 11, and video, audio and a data broadcast of the BS original broadcasting service are played back by the digital broadcasting receiver 10.

Next, an explanation of the operation of the digital broadcasting receiver 10 will be made on the basis of the descriptions of a BML document. FIG. 24 is a view showing an example of a BML document in accordance with Embodiment 8 of the present invention, and shows a BML document of a data broadcasting content included in the BS original broadcasting service. As shown in FIG. 24, an object element has a data attribute which is described in a format of “ipvod://<CDN identification>/<file path>/”. When the data broadcasting browser 108 finds an object element in a data broadcasting content while carrying out a process of playing back the data broadcasting content, the data broadcasting browser 108 notifies the element and attribute description processing unit 141 that it has found an object element. The element and attribute description processing unit 141 analyzes the object element, and, because the object element has a type attribute which is X-arib-contentPlayControl showing a VOD playback control file, determines that it is an object element for VOD and commands the VOD schema analyzer 162 to analyze its data attribute.

Because the schema of the data attribute is “ipvod”, the VOD schema analyzer 162 determines that a CDN identification is included in that URI, and demultiplexes the object element into the “CDN-B” which is the CDN type and “http://hoo.net/video/1/1.cpc” which is the URI in the CDN and performs conversion on them. The VOD schema analyzer 162 commands the IP network IF/TS demultiplexing unit B157 to which CDN-B160 is connected to acquire a file of “http://hoo.net/video/1/1.cpc”.

When receiving the VOD playback control file from the CDN-B 160 via the IP network IF/TS demultiplexing unit B157, the element and attribute description processing unit 141 delivers this VOD playback control file to the VOD playback control unit 153.

The VOD playback control unit 153 parses the contents of the VOD playback control file to determine the URI of a TTS resource and the URI of a license related information description file, and commands the IP network IF/TS demultiplexing unit B157 to acquire the required resource files. When a URI which the IP network IF/TS demultiplexing unit B157 is commanded to acquire is a domain name, the IP network IF/TS demultiplexing unit B157 converts the domain name into an address stored and then carries out the acquisition process. This IP network IF/TS demultiplexing unit B157 acquires the TTS resource from the CDN-B 160, and delivers the TTS resource to a video and audio playback unit 102, so that video and audio are played back.

As mentioned above, because the digital broadcasting receiver in accordance with Embodiment 8 is configured in such a way as to introduce a schema for implementing a CDN identification and describe the schema in a data broadcasting content which is provided by a broadcasting station, the digital broadcasting receiver can determine a CDN and a URI correctly and access them.

In above-mentioned Embodiment 8, although the explanation is made by assuming that the mono medium resource which is the reference destination is VOD, the reference destination can be any mono medium resource as long as it can be shown by an URI in one CDN.

Furthermore, in above-mentioned Embodiment 8, a new schema with a CDN identification is introduced. As an alternative, as name space in the CDN, a schema with an CDN identification which makes it possible to distinguish between non-encryption communications and encryption communications can be introduced.

In addition, in above-mentioned Embodiment 8, the example in which the URI of a VOD playback control file is defined by introducing a schema with a CDN identification, and describing a CDN identification and a file path following this schema is explained. Like in this example, by using a new schema with a CDN identification, a CDN identification, and a IP broadcast service reference path, an IP broadcast service which is broadcast in the CDN can be shown.

### INDUSTRIAL APPLICABILITY

As mentioned above, the present invention can be applied to a digital broadcasting system and a broadcasting receiver which implement simultaneous playback of broadcast data in a different network in a screen in which a broadcast content is being played back.

1. A digital broadcasting system including a plurality of service providing means each for providing a broadcasting service sent from a broadcasting network, a broadcasting facility which is provided for each of said service providing means, and a broadcasting receiver for receiving a broadcasting service which said broadcasting facility provides via one IP network, characterized in that said broadcasting facility provides a broadcasting network identifier for identifying a type of said broadcasting network, a broadcasting facility identifier for identifying said broadcasting facility, a service providing means identifier for identifying said service providing means, and a service identifier for identifying said broadcasting service, and said broadcasting receiver specifies said broadcasting network identifier, said broadcasting facility identifier, said service providing means identifier, and said service identifier to specify a broadcasting service.

2. A broadcasting receiver for a digital broadcasting system including a plurality of service providing means each for providing a broadcasting service sent from a broadcasting network, and a broadcasting facility which is provided for each of said service providing means, characterized in that said broadcasting receiver comprises:
a browser having a procedure description processing unit for receiving a broadcasting service which said broadcasting facility provides via one IP network, and for executing a procedure description included in a data broadcasting content multiplexed into a broadcast content of said received broadcasting service, and an IP broadcast network channel selection IF processing unit for issuing a command for making a channel selection of a broadcasting service specified by a broadcasting network identifier for identifying a type of said broadcasting network, a broadcasting facility identifier for identifying said broadcasting facility, a service providing means identifier for identifying said service providing means, and a service identifier for identifying said broadcasting service, which are added to said data broadcasting content, said browser playing back said data broadcasting content; and
an IP broadcast network channel selection managing unit for making a channel selection of a broadcasting service according to the broadcasting service channel selection command of said IP broadcast network channel selection IF processing unit.

3. The broadcasting receiver according to claim 2, characterized in that the browser includes an IP broadcast network broadcasting service list request IF processing unit for making a request for an IP broadcasting service list of broadcasting services each comprised of a broadcasting network identifier, a broadcasting facility identifier, a service providing means identifier, and a service identifier, and said broadcasting receiver includes an IP broadcast network channel selection information output unit for outputting an IP broadcasting service list of all broadcasting services currently being broadcast according to the request from said IP broadcast network broadcasting service list request IF processing unit.

4. The broadcasting receiver according to claim 3, characterized in that the IP broadcast network broadcasting service list request IF processing unit outputs a narrowing condition for specifying one or more of a broadcasting network identifier, a broadcasting facility identifier, a service providing means identifier, and a service identifier, and said broadcasting receiver includes a service searching processing unit for searching for a broadcasting service which meets said narrowing condition from among the IP broadcasting service list outputted from the IP broadcast network channel selection information output unit to output an IP broadcasting service list of said broadcasting service which meets said narrowing condition.

5. A broadcasting receiver for a digital broadcasting system including a plurality of service providing means each for providing a broadcasting service sent from a broadcasting network, and a broadcasting facility which is provided for each of said service providing means, characterized in that said broadcasting receiver comprises:
a browser having a procedure description processing unit for receiving a broadcasting service which said broadcasting facility provides via one IP network, and for executing a procedure description included in a data broadcasting content multiplexed into a broadcast content of said received broadcasting service, and a broadcast wave network broadcasting channel selection IF processing unit for issuing a command for making a channel selection of a broadcasting service specified by a broadcasting network identifier for identifying a type of said broadcasting network, a transport stream identifier for identifying a transport stream, an original network identifier for showing a network via which said transport stream is transmitted, and a service identifier for identifying said broadcasting service, which are added to said data broadcasting content, said browser playing back said data broadcasting content; and
a broadcast wave network channel selection managing unit for making a channel selection of a broadcasting service according to the broadcasting service channel selection command of said broadcast wave network broadcasting channel selection IF processing unit.

6. The broadcasting receiver according to claim 5, characterized in that the browser includes a broadcast wave network broadcasting service list request IF processing unit for making a request for a broadcast wave service list of broadcasting services each comprised of a broadcasting network identifier, an original network identifier, a transport stream identifier, and a service identifier, and said broadcasting receiver includes a broadcast wave network channel selection information output unit for outputting a broadcast wave service list of all broadcasting services currently being broadcast according to the request from said broadcast wave network broadcasting service list request IF processing unit.

7. A broadcasting receiver for a digital broadcasting system including a plurality of service providing means each for providing a broadcasting service sent from a broadcasting network, and a broadcasting facility which is provided for each of said service providing means, characterized in that said broadcasting receiver comprises:
a browser including an element and attribute description processing unit for receiving a broadcasting service which said broadcasting facility provides via one IP network, and for executing element and attribute descriptions which are included in a data broadcasting content multiplexed into a broadcast content of said received broadcasting service, and an IP broadcast network reference IF processing unit for issuing a command for referring to a broadcasting service specified by a broadcasting network identifier for identifying a type of said broadcasting network, a broadcasting facility identifier for identifying said broadcasting facility, a service providing means identifier for identifying said service providing means, and a service identifier for identifying said broadcasting service, which are added to said data broadcasting content, said browser playing back said data broadcasting content;
an IP broadcast network reference managing unit for referring to some broadcast data included in the broadcasting service according to the broadcasting service reference command of said IP broadcast network reference IF processing unit; and
an IP broadcast network channel selection managing unit for making a channel selection of a broadcasting service according to said broadcasting network identifier, said broadcasting facility identifier, said service providing means identifier, and said service identifier.

8. A broadcasting receiver for a digital broadcasting system including a plurality of service providing means each for providing a broadcasting service sent from a broadcasting network, and a broadcasting facility which is provided for each of said service providing means, characterized in that said broadcasting receiver comprises:
a browser including an element and attribute description processing unit for receiving a broadcasting service which said broadcasting facility provides via one IP network, and for executing element and attribute descriptions which are included in a data broadcasting content multiplexed into a broadcast content of said received broadcasting service, and a broadcast wave network reference IF processing unit for issuing a command for referring to a broadcasting service specified by a broadcasting network identifier for identifying a type of said broadcasting network, a transport stream identifier for identifying a transport stream, an original network identifier for showing a network via which said transport stream is transmitted, and a service identifier for identifying said broadcasting service, which are added to said data broadcasting content, said browser playing back said data broadcasting content;
a broadcast wave network reference managing unit for referring to some broadcast data included in the broadcasting service according to the broadcasting service reference command of said broadcast wave network reference IF processing unit; and
an IP broadcast network channel selection managing unit for making a channel selection of a broadcasting service according to said broadcasting network identifier, said broadcasting facility identifier, said service providing means identifier, and said service identifier.

9. A broadcasting receiver for a digital broadcasting system including a plurality of service providing means each for providing a broadcasting service and a data broadcasting content sent from a broadcasting network, and a broadcasting facility which is provided for each of said service providing means, characterized in that said broadcasting receiver comprises:
a browser including an element and attribute description processing unit for receiving a broadcasting service and a data broadcasting content which said broadcasting facility provides via a plurality of IP networks, and for issuing a command for analyzing an element description which is included in the received data broadcasting content, and a command for analyzing an attribute description which is included in the received data broadcasting content, and a domain name acquiring unit for acquiring a domain name from said attribute description according to said command for analyzing the attribute description, said browser playing back said data broadcasting content; and
a domain name solution processing unit for inquiring of said plurality of IP networks to determine an IP network which can solve said domain name.

10. A broadcasting receiver for a digital broadcasting system including a plurality of service providing means each for providing a broadcasting service and a data broadcasting content sent from a broadcasting network, and a broadcasting facility which is provided for each of said service providing means, characterized in that said broadcasting receiver comprises:
a browser including an element and attribute description processing unit for receiving a broadcasting service and a data broadcasting content which said broadcasting facility provides via a plurality of IP networks, and for issuing a command for analyzing an element description which is included in the received data broadcasting content, and a command for analyzing an attribute description which is included in the received data broadcasting content, and a domain name acquiring unit for acquiring a domain name from said attribute description according to said command for analyzing the attribute description, said browser playing back said data broadcasting content; and
an IP broadcast network configuration managing unit for acquiring pieces of configuration management information which said plurality of IP networks provide respectively to determine an IP network which can solve said domain name with reference to said pieces of configuration management information.

11. A digital broadcasting system including a plurality of service providing means each for providing a broadcasting service and a data broadcasting content sent from a broadcasting network, a broadcasting facility which is provided for each of said service providing means, and a broadcasting receiver for receiving a broadcasting service and a data broadcasting content which said broadcasting facility provides via a plurality of IP networks, characterized in that said data broadcasting content has a schema in which an IP network identification showing an IP network in which said data broadcasting content exists, and name space showing a locating position in said identified IP network are described.

12. A broadcasting receiver for a digital broadcasting system including a plurality of service providing means each for providing a broadcasting service and a data broadcasting content sent from a broadcasting network, and a broadcasting facility which is provided for each of said service providing means, characterized in that said broadcasting receiver comprises:
a browser including an element and attribute description processing unit for receiving a broadcasting service and a data broadcasting content which said broadcasting facility provides via a plurality of IP networks, and for issuing a command for analyzing an element description which is included in a data broadcasting content multiplexed into a broadcast content of said broadcasting service, and a command for analyzing an attribute description which is included in the data broadcasting content when a schema comprised of both an IP network identification showing an IP network and name space showing a locating position in said identified IP network are described in the received data broadcasting content, and a schema analyzer for analyzing said schema according to a command for solving said attribute description to acquire the network identification and the name space and determine an IP network, said browser playing back said data broadcasting content.
